(19) United States
(12) Patent Application Publication
(10) Pub. No.: US 2015/0302624 A1
(43) Pub. Date: Oct. 22, 2015

(54) PATTERN BASED DESIGN APPLICATION

(71) Applicant: Genue, Inc., Southborough, MA (US)

(72) Inventor: Denise M. Burke, Southborough, MA (US)

(21) Appl. No.: 14/683,429

(22) Filed: Apr. 10, 2015

Related U.S. Application Data
(63) Continuation-in-part of application No. 14/049,378, filed on Oct. 9, 2013.

(51) Int. Cl. G06T 11/60; G06F 3/0482; G06T 11/00; G06F 3/0484

(52) U.S. Cl. CPC G06T 11/60; G06F 3/04845; G06F 3/0482; G06F 3/04842; G06T 11/001; G06T 2200/24

(57) ABSTRACT

A pattern based design tool includes a plurality of image building functions for generating visual content on an on-screen rendered area, or canvas, in which the canvas is responsive to graphical manipulations for changing the appearance of an image on the canvas. A plurality of available image building functions and image manipulation functions allow modification of the visual content on the canvas to generate a modified image, such that the canvas accumulates visual content in response to the functions. The accumulated image on the canvas is incorporated as a repeated pattern in successive drawing functions, such that the accumulated image defines a repeated portion of the successively applied drawing functions, and represents a hierarchy of previously entered images to define a sub pattern of entered items on the canvas. In this manner, a repeated pattern defines a sub-element of a drawing function.

### RELATED APPLICATIONS

This patent application is a CIP (Continuation in Part) of U.S. patent application Ser. No. 14/049,378, filed Oct. 9, 2013, entitled “PATTERN BASED DESIGN APPLICATION”, which claims the benefit under 35 U.S.C. §119(e) of U.S. Provisional Patent App. No. 61/862,749, filed Aug. 6, 2013, entitled “PATTERN BASED DESIGN APPLICATION,” both incorporated herein by reference in entirety.

### BACKGROUND

Conventional graphic designs for various display mediums typically require substantial time and artistic ability. Such designs are employed in a variety of contexts, often for a hardcopy or physical medium such as paper or fabric, including clothing, advertising and brand designation, scrapbooks, greeting cards, and other contexts where a visually pleasing aesthetic appearance is desired. In recent decades, inexpensive computer hardware has enabled graphical design to deviate from conventional paper mediums. Electronic renderings of graphical images may be developed on a visual display using drawing tools, rather than conventional ink or paint, and saved in a digital (electronic) format for subsequent recall and editing. Digital based designs may be electronically altered on the visual display, and modified or transformed more dynamically than conventional paper or hardcopy mediums, which are typically difficult or impossible to change or modify once image items are rendered. A graphical user interface (GUI) provides drawing tools for a user/artist to enter items of an image, similar to a pen or brush in conventional mediums, but allows saving, erasure and modification of the items in the on-screen rendered image. Upon completion, the on-screen rendered image may be output in a hardcopy form such as paper for subsequent display.

### SUMMARY

A pattern based design tool includes a plurality of image building functions for generating visual content on an on-screen rendered area, or canvas, in which the canvas is responsive to graphical manipulations for changing the appearance of an image on the canvas. A plurality of available image building functions and image manipulation functions allow modification of the visual content on the canvas to generate a modified image, such that the canvas accumulates visual content in response to invocation of the image building functions and the image manipulation functions. The image on the canvas is incorporated as a repeated pattern in successive drawing functions, such that an accumulated image defines a repeated portion of the successive applied drawing (image building) functions, and represents a hierarchy of previously entered images to define a sub pattern of entered items on the canvas. In this manner, a repeated pattern defines a sub-element of an entered item without requiring repeated entry of the entire patterned sub-element as with conventional approaches.

In configurations discussed further below, a visual rendering of an image is displayed on a GUI device, such as an iPad®, Android®, Mac/PC or similar handheld, tablet, or desktop computing device. The image is a collection of graphical items such as lines, shapes, and other geometric entities and colors.

In the configuration depicted herein, image building functions add the items to the image, and the image manipulation functions arrange the items, such as rotating, scaling, cropping, transposing, and shading/coloring, for example. The graphical operations include both image manipulation and image building functions.

A canvas is a designated area, or window on the GUI in which the image is rendered during development, and effectively aggregates the result of the image building functions and the image manipulation functions. A pattern is a depiction of the image on the canvas taken at a point in time. The pattern may then be saved and employed in other images as a sub-image. The sub-image is replicated as a sequence in another item, such as a line comprised of a sequence of an image, typically in a reduced scale. Since the patterns may comprise sub-images on another canvas, which may then itself define another pattern, the patterns define a hierarchy in which items in the pattern include other patterns.

Configurations herein are based, in part, on the observation that graphical designs for visual rendering operations often require time consuming, repetitive manipulations of user input commands (keystrokes, pointer movements, or mouse clicks) to define visual elements. Unfortunately, conventional approaches to digital graphical design suffer from the shortcoming that substantial effort and/or artistic ability is required in order to define a graphical image, and certain users may not have sufficient time or artistic ability to adequately create a suitable image with pleasing proportion and symmetry, for example.

Accordingly, configurations herein substantially overcome the above described shortcomings of conventional digital design by providing a method of entering a graphical image through a series of image building functions, such as line and shape entry functions, and incorporating the graphical image as a repeated pattern in a hierarchy of graphical images that employ the graphical image as the foreground of the image building functions. The hierarchy of images is represented in a rendered form on the on-screen visual rendering area provided by the canvas, and may be saved for later incorporation in the hierarchy. The canvas, therefore, may employ image building functions that incorporate a previously entered image as a sub-pattern or subimage in a current image by repeating the subimage in the foreground representation of lines, shapes and other on-screen renderings. For example, an initial image may contain an assortment of lines and shapes, and the initial image scaled and employed in a successive image such that a drawn line includes a repeated pattern of the initial image as a subimage in the foreground of the line (as opposed to a solid black or other foreground color).

A selection of an image manipulation function may be employed to manipulate and modify the entered items to augment the visual appearance. For example, the image manipulation functions may stretch, rotate, or invert shading of the entered items, or may arrange the entered items by selective manipulation to certain quadrants or portions of the canvas area, such as rotating a subset of quadrants while leaving other quadrants unmodified.

Depicted further below is a pattern based design application that includes a plurality of image building functions for generating visual content, such that the canvas is responsive to graphical manipulations for changing the appearance of an image on the canvas, and a plurality of image manipulation functions for modifying the visual content to generate a modified image. The canvas accumulates visual content to depict invocation of the image building functions and the image manipulation functions.

The pattern based design application performs a method of generating a visual image by adding graphical material to a visual rendering of an image, in which the added graphical material includes a repeated pattern of previously rendered graphical material. In an example configuration, the pattern based design application defines the pattern by building a first pattern from at least one graphical operation, in which the graphical operation generates visual content to the pattern, and builds a second pattern from another graphical operation, such that the second pattern adds content by repeated application of the first pattern such that the visual content of the first pattern defines a repeated portion in the second pattern.

In the example configuration, the graphical operations include image building functions for generating visual content, and image manipulation functions for modifying the visual content, for adding and manipulating the rendered items on the canvas, respectively. The image building functions therefore add visual graphical material to an image via the canvas, and the manipulation functions modify the rendering in the canvas by reorganizing material already rendered.

In a particular arrangement, the first and second patterns define successive levels in a hierarchy of patterns, such that each level in the hierarchy includes a repeated sequence of the patterns in a previous level of the hierarchy. The successive (higher) levels therefore replicate patterns from lower levels in a sequence to form lines, shapes, solids and other geometric renderings using the lower level patterns.

From a user interface perspective, the visual images are therefore generated as graphical designs by selecting an image building function for adding visual content on a canvas, in which the canvas is responsive to graphical manipulations for changing the appearance of an image on the canvas, and selecting an image manipulation function for modifying the visual content on the canvas to generate a modified image. A user repeats selection of the image building functions and the image manipulation functions in an iterative manner to accumulate an aggregate image based on successive modified images, by adding successive items to the canvas. Once a particular aggregate image is completed on the canvas, the image may be saved as a pattern, such that the aggregate image is selected and employed by the user as an element of an image building function in a successive image. A plurality of the aggregate images may be saved in a repository of selectable images.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a an environment suitable for use with generating and disseminating graphical designs according to configurations herein;

FIG. 2 is a diagram of graphical design generation on a personal computing device in the environment of FIG. 1;

FIG. 3 is a flowchart of graphical design generation using the computing device of FIG. 2;

FIG. 4 is a display screen of a computer application for generating graphical designs according to the method of FIG. 3;

FIG. 5 is an example of a design using the application of FIG. 4;

FIG. 6 shows a color selection screen for color selection in the application of FIG. 4 using image building functions; and

FIG. 7 shows the design of FIG. 5 as a subimage in a larger design using image building functions;

FIG. 8 shows the design of FIG. 5 modified using an image manipulation function;

FIG. 9 shows another design similar to FIG. 5;

FIG. 10 shows a trace line of the design of FIG. 9;

FIG. 11 shows a design using the design of FIG. 9 as a subimage;

FIG. 12 shows a design using a repeating quadrant of the design of FIG. 9;

FIG. 13 shows the design of FIG. 9 using a repeating row function;

FIG. 14 shows the design of FIG. 9 using repeating columns;

FIG. 15 shows the design of FIG. 9 using a matrix function;

FIG. 16 shows the design of FIG. 9 using a column rotation function;

FIG. 17 shows a shape function and fill using the designs of FIGS. 9 and 11;

FIG. 18 shows a pattern line using the design of FIG. 11;

FIG. 19 depicts a graphical user interface having partition based image manipulation and building functions;

FIGS. 20A-21D show a quadrant based image manipulation function for generating seamless edges between adjacent subimages;

FIG. 22 depicts a horizontal bifurcation similar to the vertical bifurcation of FIG. 19;

FIG. 23 depicts a quadrant partition with inverse reflection;

FIG. 24 depicts a quadrant partition with corresponding (same orientation) reflection;

FIG. 25 depicts a quadrant (90 degree) partition with diagonal reflection;

FIG. 26A depicts partitioning based on arbitrary angles;

FIG. 26B shows interconnected partitions defined at a 60 degree angle; and

FIG. 27 depicts shape and enhancement drawing operations.

### DETAILED DESCRIPTION

The examples discussed below depict an example implementation of a graphical user interface (GUI) for performing the disclosed methods. Example GUI controls, such as buttons, checkboxes and sliders, are shown for receiving input through the user device, via suitable input mechanisms such as pointing devices and keyboards. Alternate approaches may employ alternate arrangements of the GUI controls; emphasis is on the computation and rendering features disclosed. The disclosed system provides a user interface responsive to a variety of functions and graphical operations, including image building functions and image manipulating functions, as depicted below, and are invokable in a plurality of sequences depending on user direction. The approach disclosed below demonstrates an example invocation of the various graphical operations for illustrating the principles and methods of the proposed approach; other selections and sequences of the graphical operations may be performed.

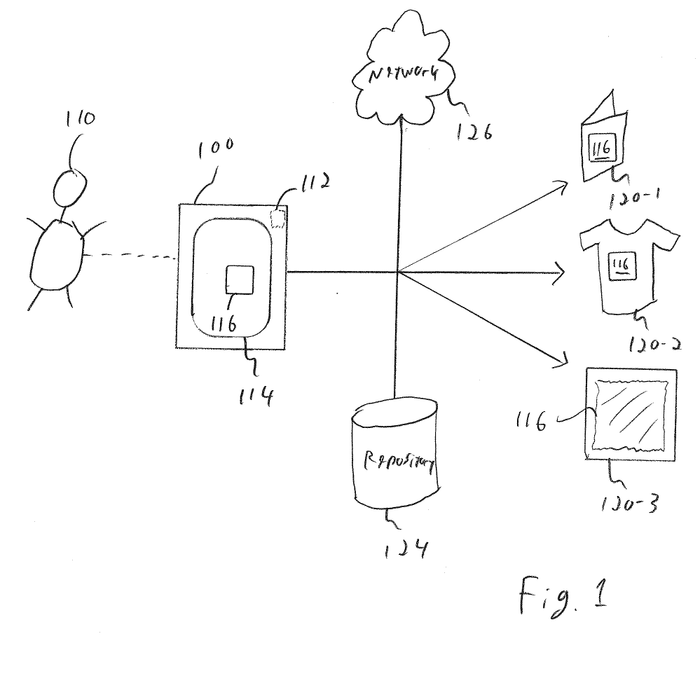

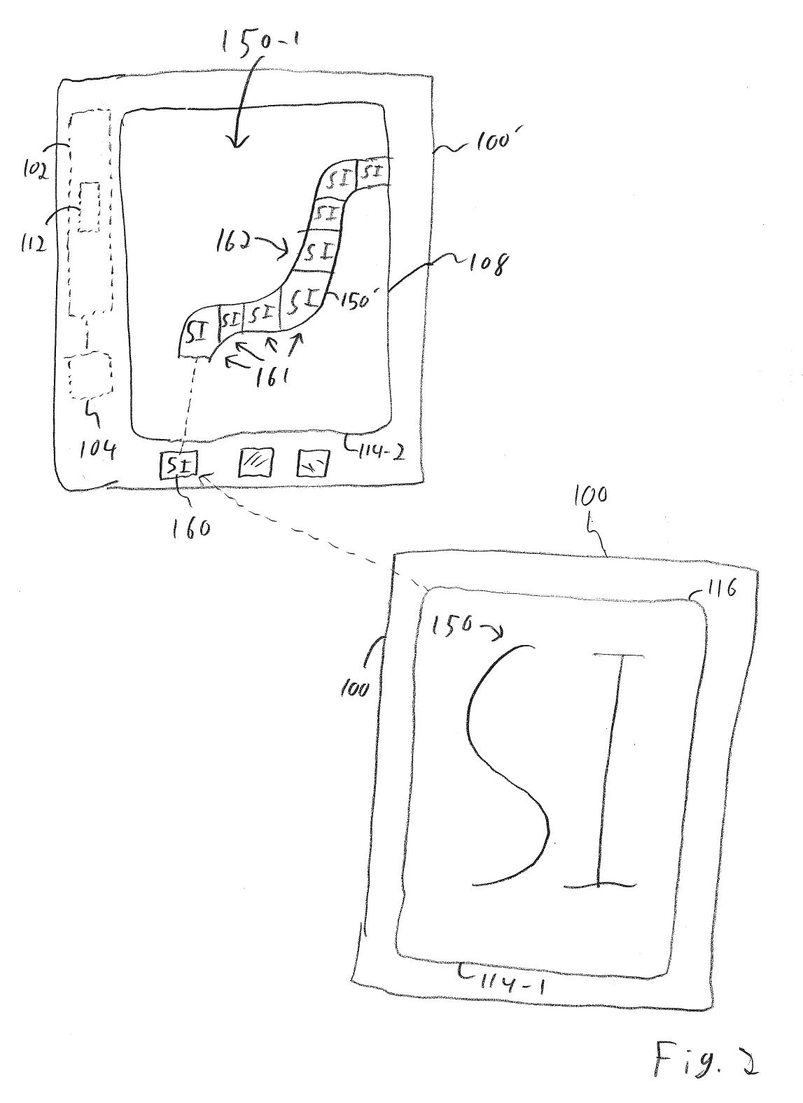

FIG. 1 is a context diagram of an environment suitable for use with generating and disseminating graphical designs according to configurations herein. Referring to FIG. 1, a personal computing device 100 is responsive to a user 110 for executing a design application 112 (app). The personal computing device 100 may be any suitable microprocessor appliance, such as a tablet, smartphone, laptop (e.g. iPad®, iPhone®) or other suitable portable or desktop computing device. The app 112 executes (launches) on the device 100 for interacting with the user 110 for creating and generating a design 116 on a rendering area 114 of the device, typically a display screen such as an LED or LCD display. The design 116 is a visible, aesthetic rendering expressed as a pixelated image, and may be output, transmitted, or printed/displayed on a suitable hardcopy rendering medium, such as a printer. The generated designs 116 may be employed in physical form on items such as books and cards 120-1, textile and clothing prints 120-2, and file based hardcopy or solid rendering, including advertising media such as posters, brochures, and signage 120-3 (120 generally). Any suitable rendering and/or manufacturing format may be the destination of the physically rendered design, depending on the output file format and available rendering equipment 120. For example, apparatus for designing on wood, plastics and other materials that involve CNC machinery, water-jet cutting, laser cutting, and garment printers. The application 112 employs corresponding drivers and output files for generating device specific output file formats that are employed for creating patterns on various surfaces, The designs 116 may also be transported and stored as digital files on a disk or non-volatile media such as repository 124, or transported by a public access network 126 such as the Internet, for transfer, media posting, or subsequent rendering.

FIG. 2 is a diagram of graphical design generation on a personal computing device in the environment of FIG. 1. Referring to FIGS. 1 and 2, the app 112 executes on the computing device 100 and interacts with the user via the rendering area 114-1, or screen, and receives input via a pointer device mechanism, which may be a touchscreen feature of the device 100 or a mouse, touchpad, or keyboard, as is typical with such devices. The app 112 executes in a memory 102 of the device 100, and is responsive to a processor 104 for receiving input and display/rendering output, also typical of such devices.

In the example shown, the application 112 is employed to create an initial image 150, shown in the rendering area 114-1. The initial image 150 defines a subimage 150′ (shown as “SI”) in a subsequent rendering 114-2, rendering another image 150-1. In operation, a pattern icon 160 defines the stored rendering area 114-1 as a pattern, and a subsequent drawing operation invokes the subimage 150′ as an element 161 in a pattern line 162, such that the line is comprised of consecutive renderings of the subimage 150′, rather than a solid black or other color. In other words, in common drawing applications employing a “pen” operation, the subimage 150′ defines the pen color, rather than another solid color or pattern. The line elements 161 are therefore taken from other images, rather than from predetermined solids or fill sequences. As will be discussed further below, a variety of drawing tools are available, and the new image 150-1 can itself be stored and referenced as a subimage 150′ in subsequent designs. A library or repository 124 of stored patterns may be referenced and invoked as subimages 150′ in a current image 150-1.

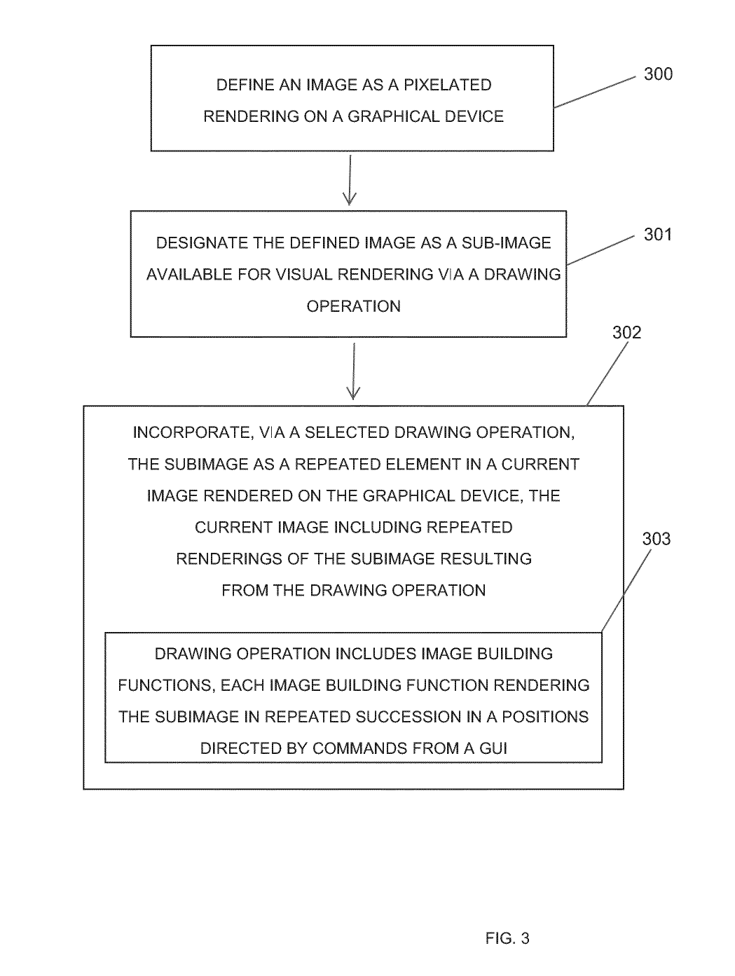

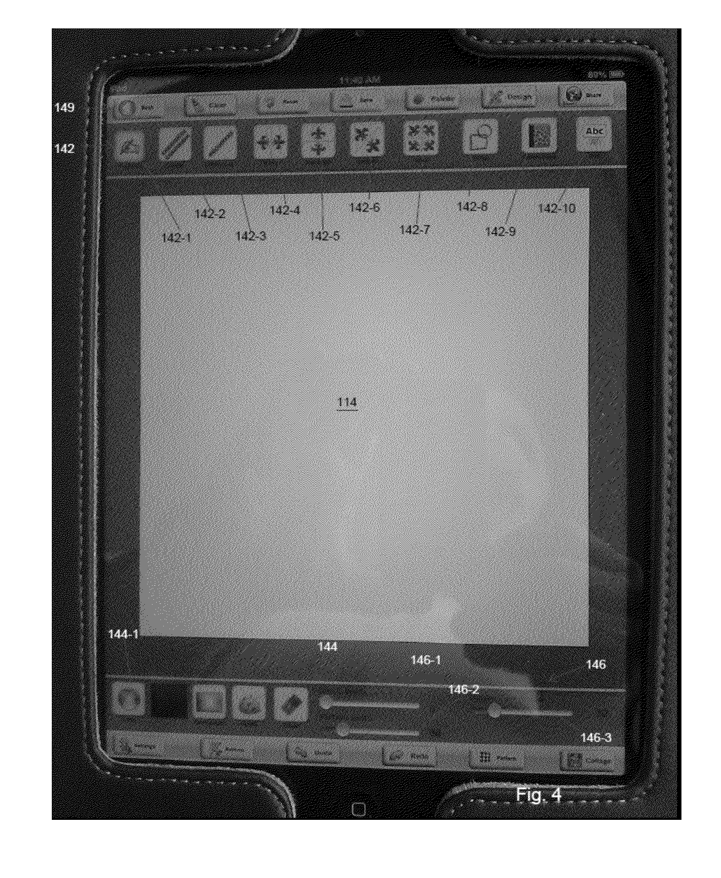

FIG. 3 is a flowchart of graphical design generation using the computing device of FIG. 2. Referring to FIGS. 1-3, the method for graphical design rendering as disclosed herein includes, at step 300, defining an image 150 as a pixelated rendering on the graphical device 100, and designating the defined image 150 as a sub-image 150′available for visual rendering via a drawing operation, as depicted at step 301. A selected drawing operation incorporates the subimage 150′ as a repeated element in a current image 150 rendered on the graphical device 100, such that the current image includes repeated renderings of the subimage 150′ resulting from the drawing operation, as shown at step 302. In the example arrangement, therefore, the drawing operation includes image building functions, such that each image building function renders the subimage in repeated succession in a positions directed by commands from a GUI (Graphical User Interface), as depicted at step 303. The subimage 150′ defines the pen or brush employed for rendering the (now primary 150) image, just as conventional pen or brush drawing operations employ a solid black or other color. The drawing operation iteratively repeats the inclusion of an image 150 as a sub-image 150′, such that the current image becomes the subimage rendered as the repeated element in a successive current image. The resulting line appears as a concatenation of the subimage (at a reduced size) as if it was a foreground color rendered by the drawing operation.

In the application 112 depicted above, an image 150, also called a design, is defined as a composition of graphic elements that may produce a symmetrical rendering: comprised of line-shapes-motifs defined by consistent planar direction and positioning—this renders patterns—with similar and recognizable attributes within the design. Alternatively, a design may be an asymmetrical rendering: comprised of non related elements with dissimilar attributes, abstract shapes (not following consistent Planes—ie: a squiggle line—doodle shape), random patterns denoted by dissimilar repeats, all over direction, some recognizable symmetrical elements and planar direction may be incorporated but are a subset or portion of the design.

Graphic images 150 are created by a successive process using the application 112. An exemplary sequence is as follows: from a single pixel or element->combination of pixels symmetrically defined—becomes a line, asymmetrically defined—becomes a stroke->a combination of lines with consistent dimensions and planar directionality becomes a shape (a shape defined as having endpoints pixels connecting endpoint to endpoint (vertices connect)—strokes with connecting endpoints become a motif->a combination of shapes aligned consistently in direction and position become a pattern-or a combination of motifs without consistent direction. Position become a random pattern->a composition of patterns become a design. Alternatively, an input of a graphic image may be edited to create a new design, using an external import or a previously edited image 150. Thus, any suitable combination will also render a new design, providing a hierarchical inclusion of designs within other designs.

Configurations disclosed herein differ from conventional drawing and rendering approaches because of the dynamic and interactive design process. The user's combination choices and input are variable and therefore will render an output of design that is unique, to the user's tastes, and original.

Combination choices can further be defined as original due to features such as the sequence followed, number of times a user interacts, positioning of graphic elements on foreground or background layers, choices to edit, repeat design—symmetrical composition or collage as an asymmetrical design. During the design process the user can create original color palettes, textures, and pattern lines for successive building and design creation—pattern lines for drawing, pattern book—saved whole image for combining, originate color choices based on color picker selection and edit hue and transparency—all to cater to desired effects of user. Any particular design (image 150) can be altered through repeats, scale size, dimensions and dpi of output.

Repeats and symmetrical patterning are based on predefined square grid—further segmented by quadrants and x and y axis's using symmetrical slicing. This was chosen basically because of the device dimensions and to maximize touch screen availability for user experience. However, grid may be changed to triangle layout and also with relation to directionality can be manipulated by 360 degrees. See attached drawings.( triangle—hexagon folders)

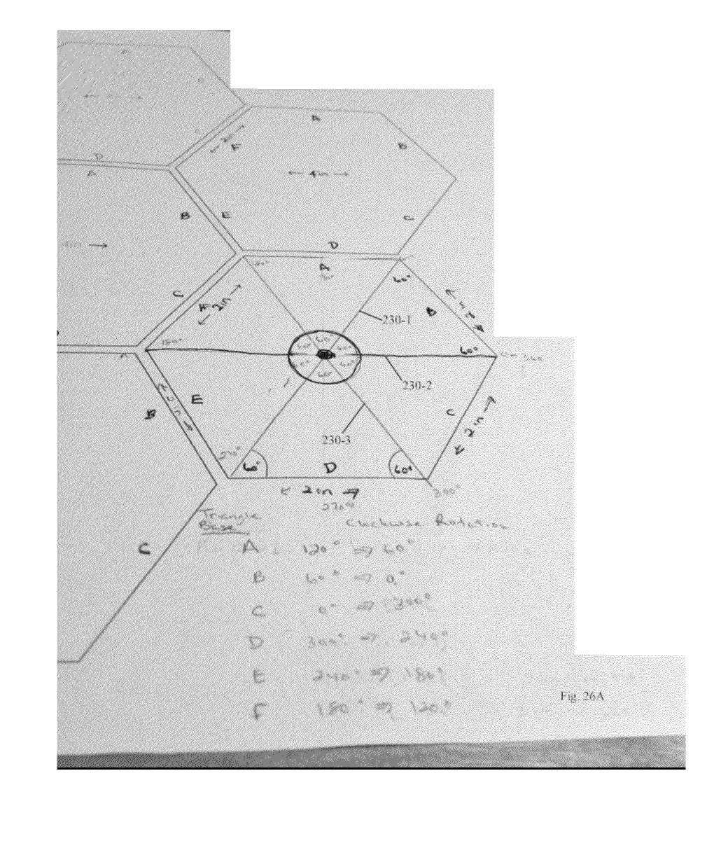

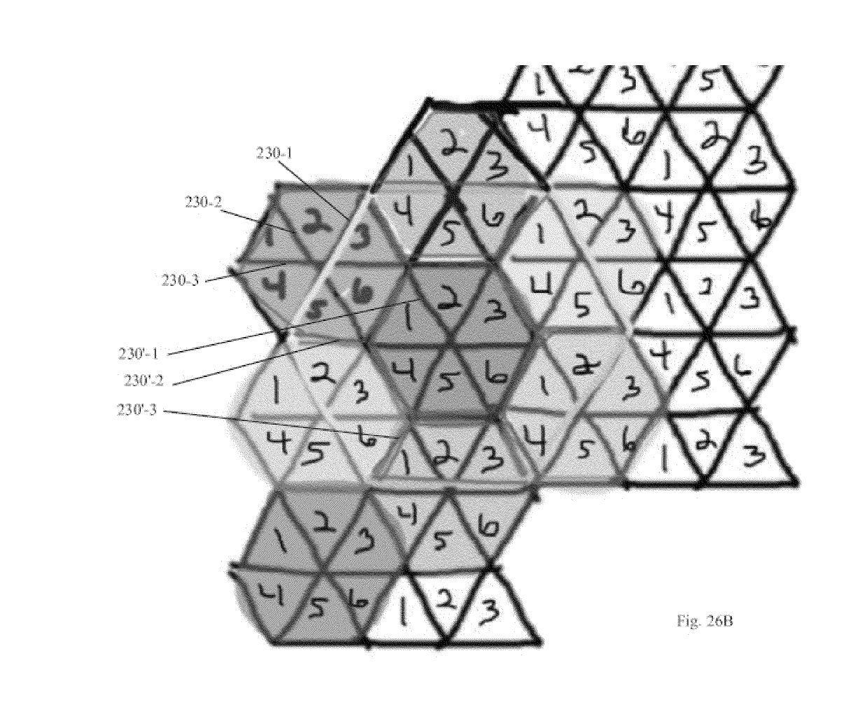

Quadrant and partitioning features may include predetermined angular definitions, but may be altered, as discussed below with respect to FIGS. 26A and 26B. The application invokes presets and variables to software so that user could specify directionality based on degrees for rotations, reflections and repeats—this is demonstrated in random crop mode—(button next to random patterning on bottom of screen). This function allows the user to select a point and manipulate it by direction and position using presets for same direction along axis or opposing/inverse direction along an axis, or choosing a point and positioning it arbitrarily.

From initial input to final design—at anytime, upon saving, the user has the ability to store their graphic image. The application 112 provides a storage system for user organization and filing of images—pattern line—pattern book—global patterns—palette book—and gallery, to organize and facilitate saving the images to the hardware device. While the device 100 may be limited to certain file formats and sizing, while the application 112 provides resizing, resampling, keeping aspect ratio and clarity even if dpi changes and size of design image are changed. Designs may be saved and exported in different file formats and file sizes for own printing or sent to manufacturing. The application has incorporated this feature to help users conform to pre-press parameters required by digital printers and to produce design ready files needed by manufacturers of products. Such images 150 are particularly beneficial to products relating to material and 2-D surfaces printed upon, such as paper-fabric-wood-ceramic/glass-plastic-metal substrates.

FIG. 4 is a display screen of the computer application 112 for generating graphical designs 116 according to the method of FIG. 3. Referring to FIGS. 2 and 4, the device 100 has a visual display screen 108 including the rendering area 114-1 . . . 114-2 (114 generally) for displaying the current image 150, and for displaying controls 140 in a perimeter or margin area around the rendering area 114, sometimes referred to as a canvas, to denote the aesthetic nature of the rendered images 150. The controls 140 allow invocation of image building functions and image manipulation functions for applying to the image 150 in the rendering area. Drawing tools 142 perform addition of specific visual elements, such as lines and shapes, and allow for manipulating those shapes. Drawing medium controls 144 define current colors and direction of the drawing tools 142, such as background and color palette selections. Drawing settings 146 control parameters of the drawing tools 146, such as line weight, pattern scale and transparency. Edit controls 148 direct the commands entered, such as undo/redo and toggling edit modes, and administrative controls 149 control the rendering area 114 by saving and recalling images 150 from storage.

A plurality of drawing operations are available, generally defining image building functions, which add graphic material to the image 150, and image manipulation functions, which augment or duplicate graphic material already a part of the image 150. In the example configuration, therefore, the drawing operations includes a suite of image manipulation function, each operable for receiving an identity of an element, typically via a pointer (mouse) click, in which the element is a previously rendered portion of the current image. The selected element, or portion of the image 150, is rendering the identified element in a different location, often after duplication according to a symmetry line or quadrant arrangement.

In FIG. 4, a pen or brush function 142-1 draws a solid line, a single pattern line 142-2 draws a single width line of a pattern, similar to FIG. 2, and a double pattern line 142-3 draws parallel renderings of pattern lines. Slider 146-1 controls the width of the pen/brush function 142-1, and slider 142-2 controls the pattern width. Slider 146-3 determines the width between the patent lines in the double pattern line function 142-3. A current pattern is selected for use as a subimage 150′ from previously stored patterns using design button 149-1.

Image manipulation buttons 142-4 . . . 142-7 perform split and quadrant functions that subdivide the canvas 114 along horizontal, vertical, diagonal, or quadrant lines and replicate the current design in each split. Shape button 142-8 allows selection of predetermined geometric shapes. Previously entered designs 116 are stored and selectable via a pattern book 142-9, and text entry is facilitated via a typewriter buttons 142-10.

The graphical device 100 renders foreground segments and background areas, such that the image building functions are configured to render the elements in the current image 150 as the foreground segments visually rendered over the background areas, and the background areas remaining visually unchanged until obscured by the foreground segments. The drawing operations overwrite a previously rendered foreground segment with a successively rendered foreground segment, such that the successively rendered foreground segment defines the visual appearance. As the visual rendering includes displaying the image 150 on a pixel based device 100, the drawing operations shift pixel colors of the rendered foreground segments from that of the background areas using the image manipulation functions, based on the pen location and subimage 150′. The rendered the elements include lines, shapes, boxes, areas, or any geometric arrangement as defined by the subimage 150′ and according to a selected image building function.

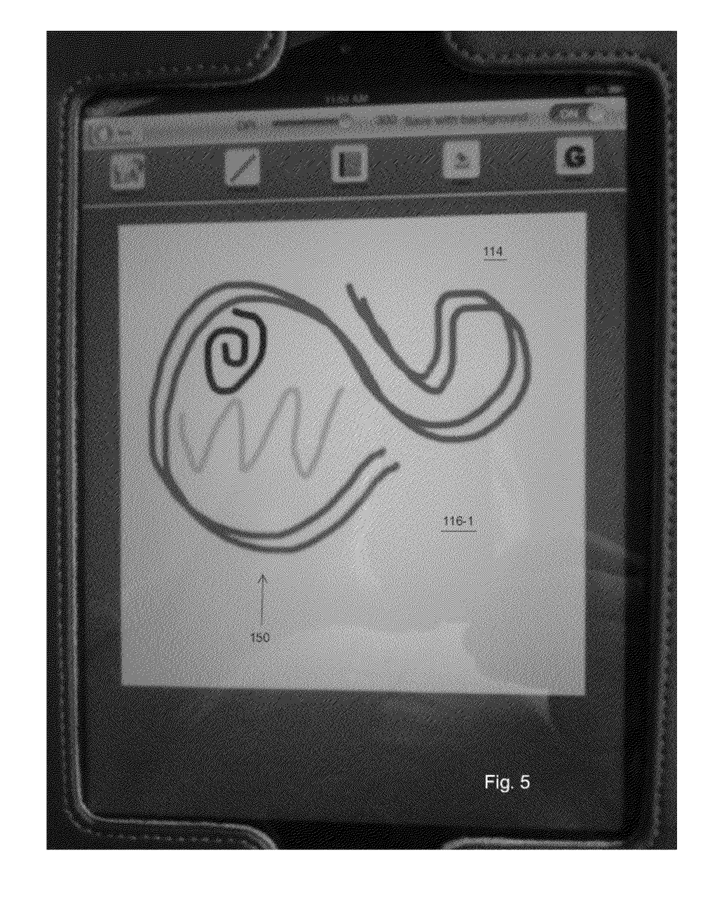

FIG. 5 is an example of a design using the application of FIG. 4. FIG. 5 shows an arbitrary design 116-1 from application of the pen function 142-1. Alternatively, a design 116 may emanate from photographic input, imported from other drawing tools, or saved designs 116 previously developed using the application 112.

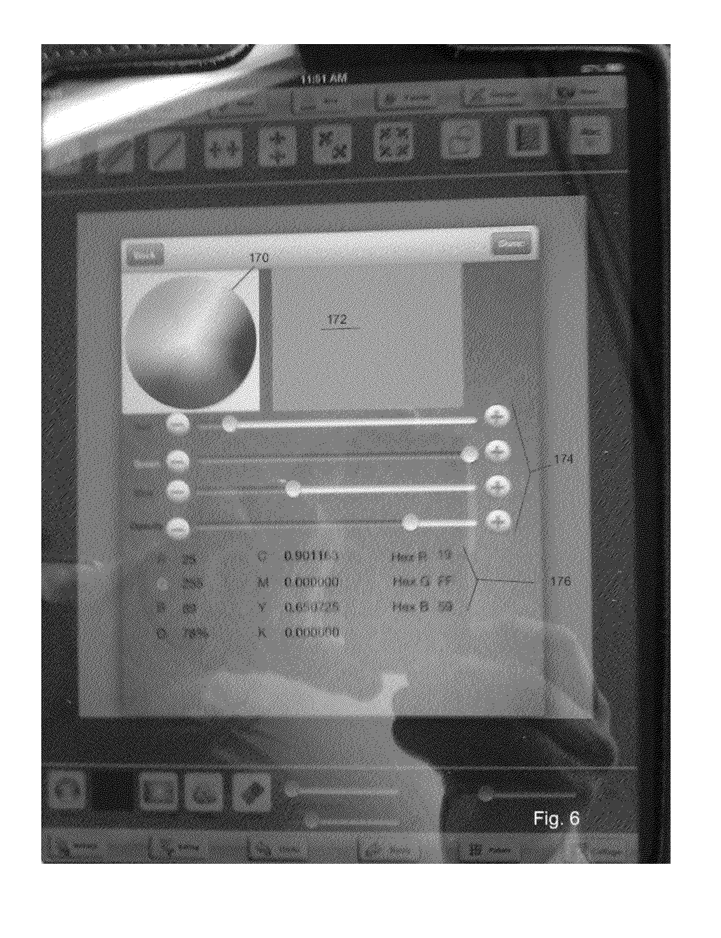

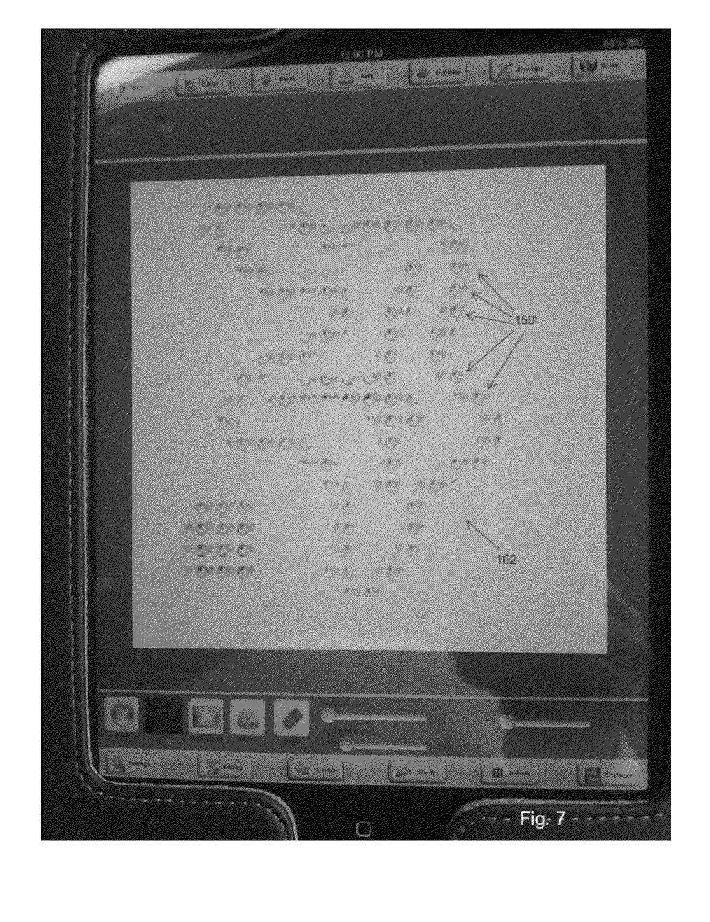

FIG. 6 shows a color selection screen for color selection in the application of FIG. 4 using the drawing medium button 144-1. A color wheel 170 allows visual selection of color and saturation. A sample window 172 shows the currently selected color. Hue selection sliders 174 allow varying intensity of different color elements, such as red, green and blue elements to further refine the hue, saturation and intensity. Color value displays 176 show numeric values for each of the color elements. Generally, a user begins color selection using the color wheel 170, to set initial values for the values shown in the color value displays 176, and then “fine tunes” the values using the hue selection sliders 174.

FIG. 7 shows the design 116-1 of FIG. 5 as a subimage in a larger design using image building functions. Referring to FIGS. 1, 5 and 7, the image 116-1 is rendered as a subimage 150′ by forming elements 161 of a pattern line 162, drawn using the single pattern line button 142-3. FIG. 7 further illustrates the hierarchy of designs depicted by the subimage 150′, included as an element 161 of a larger primary or current image 150, which may span a plurality of levels. Thus, a user may continue to build successive images 150 using one or more subimages 150′ previously generated. In this manner, the disclosed approach presents method of generating a visual image 150, by employing the GUI for adding graphical material to a visual rendering of an image 150, in which the added graphical material includes a repeated pattern of previously rendered graphical material, shown as subimage 150′, which may be any previously developed design 116.

The pattern (design 116) development further includes building a first pattern from one or more of the graphical operation (image building and generating functions), such that the graphical operation generates visual content in the pattern. The first pattern becomes the subimage 150′. The user 110 builds a second pattern from another graphical operation, in which the second pattern adds content by repeated application of the first pattern such that the visual content of the first pattern defines a repeated portion in the second pattern. The second pattern is the current or primary image 150 because it is incorporating other (i.e. the first pattern) patterns as elements 161.

Upon repeated application of images 150 and subimages 150-1, the first and second patterns may define successive levels in a hierarchy of patterns, such that each level in the hierarchy includes a repeated sequence of at least one of the patterns in the previous level of the hierarchy. The graphical operations invoked may include the image building functions for generating visual content, and image manipulation functions for modifying the visual content, as described above.

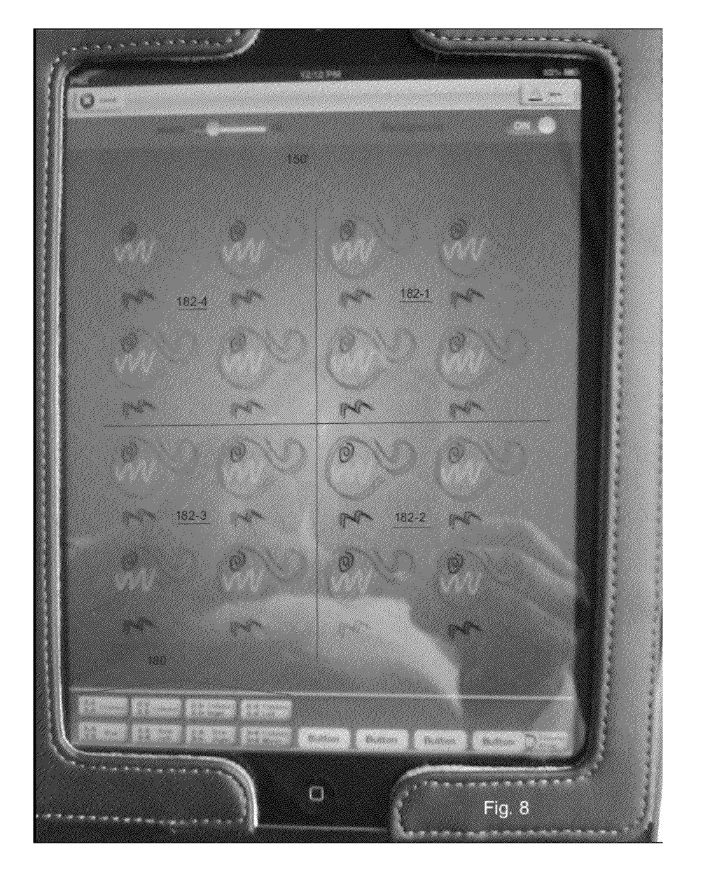

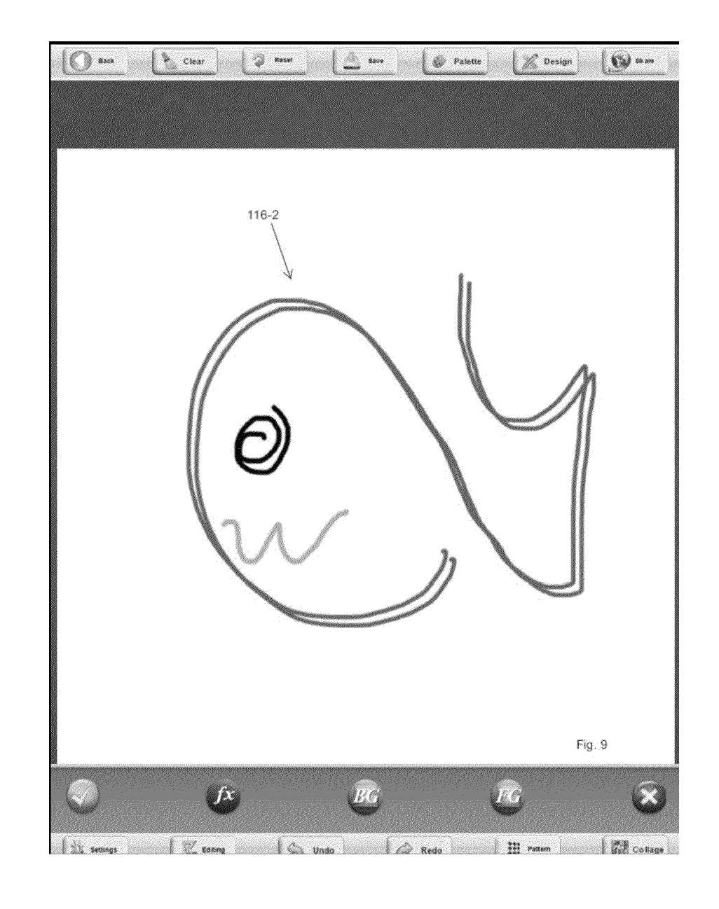

FIG. 8 shows the design of FIG. 5 modified using an example image manipulation function. Referring to FIGS. 5 and 8, a quadrant function is operable to subdivide the image 150 into quadrants, such that each area of the quadrant includes a duplication of the design 116-1. The depicted rendering includes a 4*4 arrangement of the subimage 150,′ which may further be subdivided into additional quadrants 182-1 . . . 182-4 (182 generally). A plurality of quadrant functions 180 provide selective rotation of a subset of the quadrants 180.

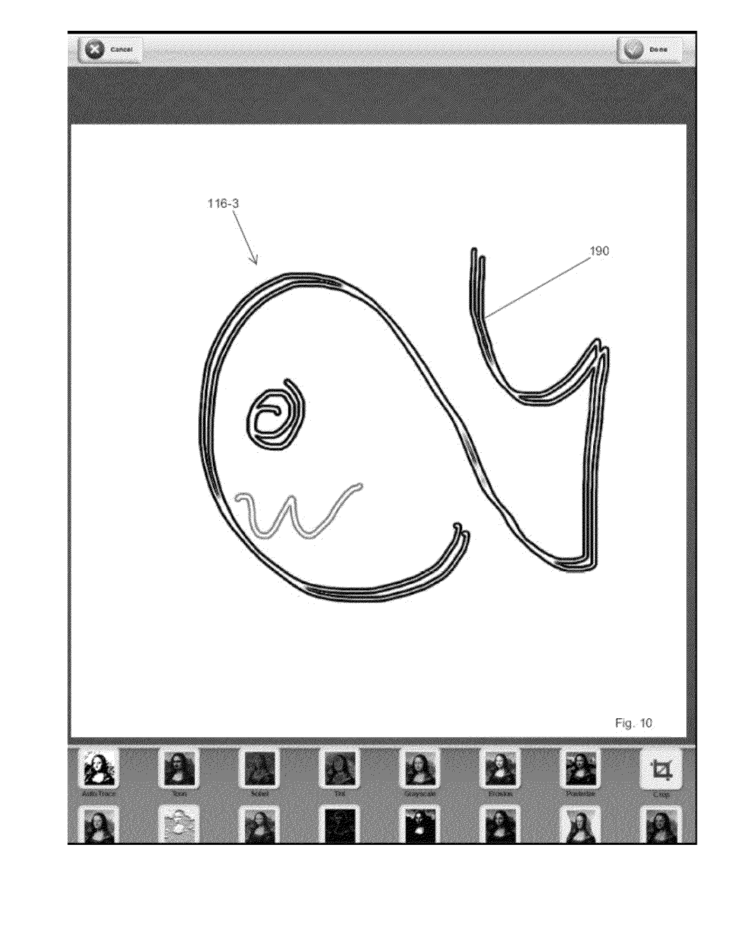

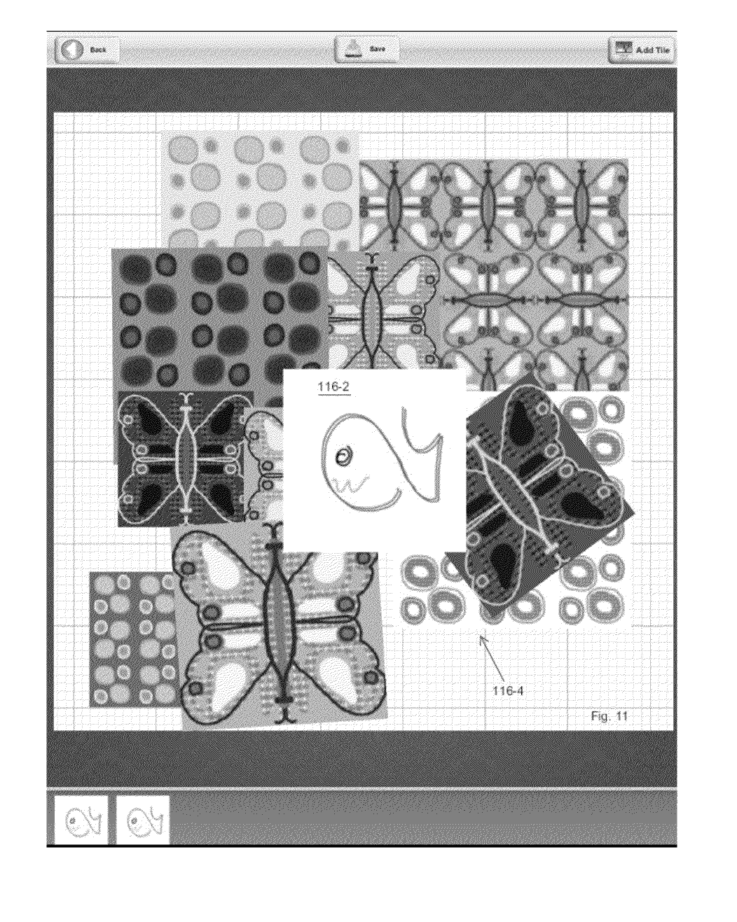

FIG. 9 shows another design similar to FIG. 5. Referring to FIGS. 9 and 10, FIG. 10 shows a trace line operation 190 and rendering 116-2 of the design of FIG. 9.

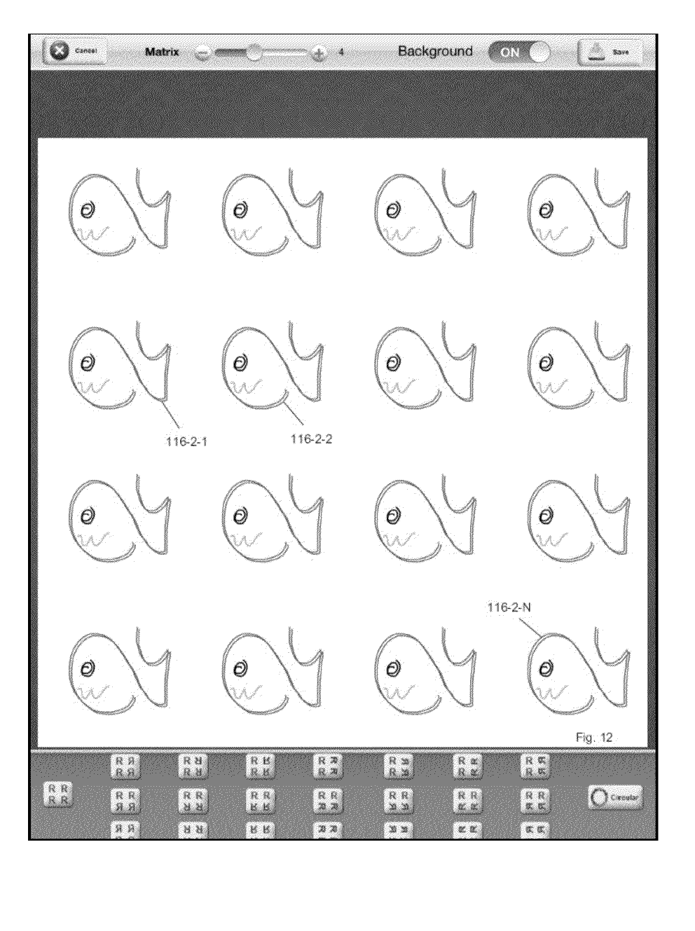

FIG. 11 shows a design 116-4 using the design 116-2 of FIG. 9 as a subimage, illustrating the hierarchy of designs. Design selection icons 145 are invoked to select previously stored designs 116 as the pen or brush for rendering. The remainder of design 116-4 includes a collage of other designs 116, also stored as individual designs

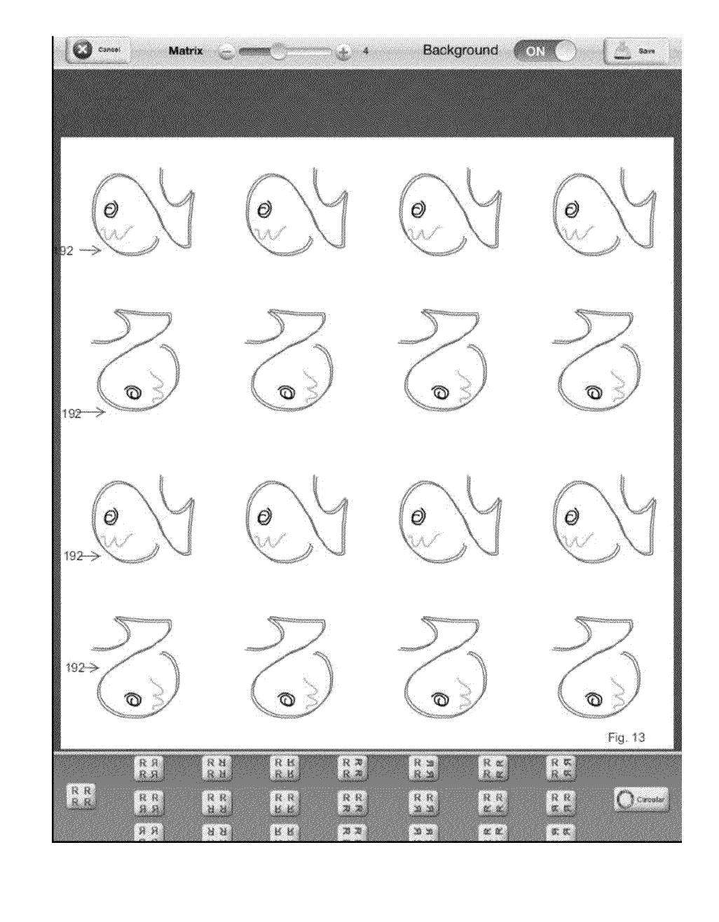

FIG. 12 shows a design using a repeating quadrant of the design of FIG. 9. Referring to FIG. 12, a base image, 116-2 shown, is replicated in a row and column format, similar to FIG. 8. Images 116-2-1 . . . 116-2-N, in general (a 4*4 rendering of N=16 instances is shown). Various image manipulation functions are invokable on the base image 116-2, as shown in the following Figures.

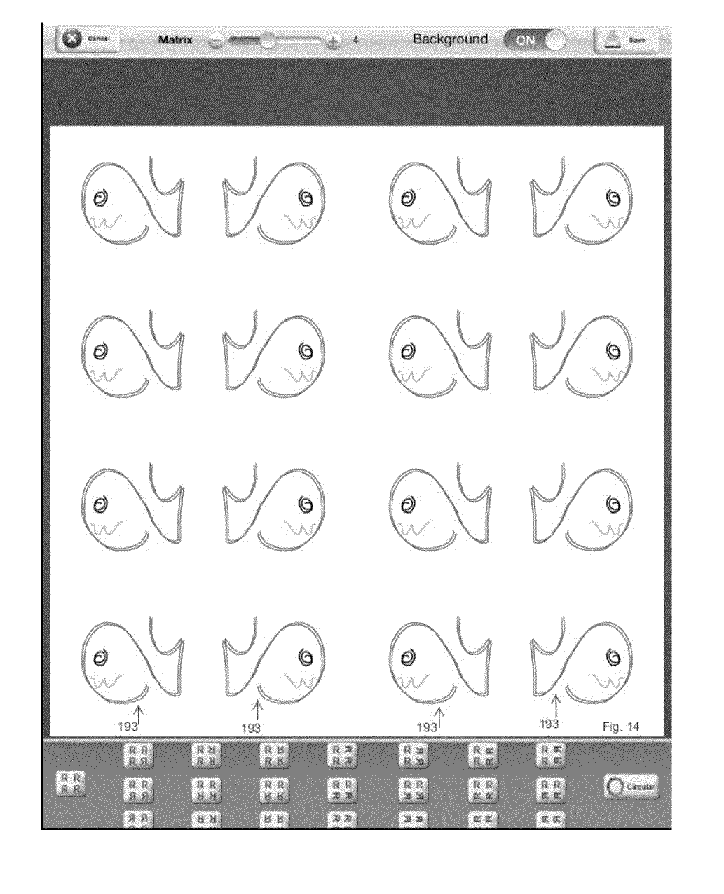

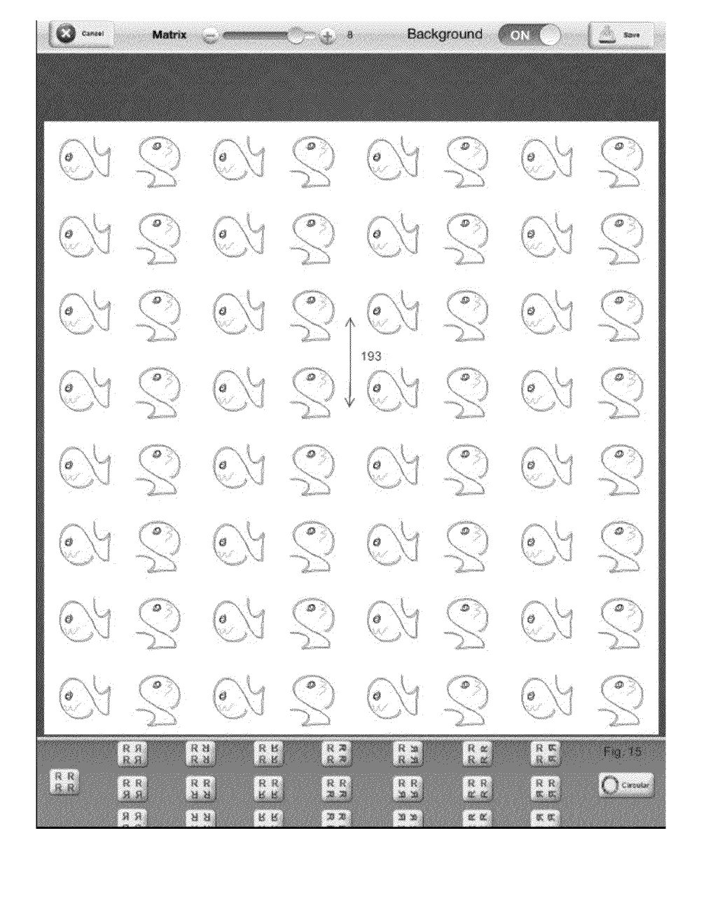

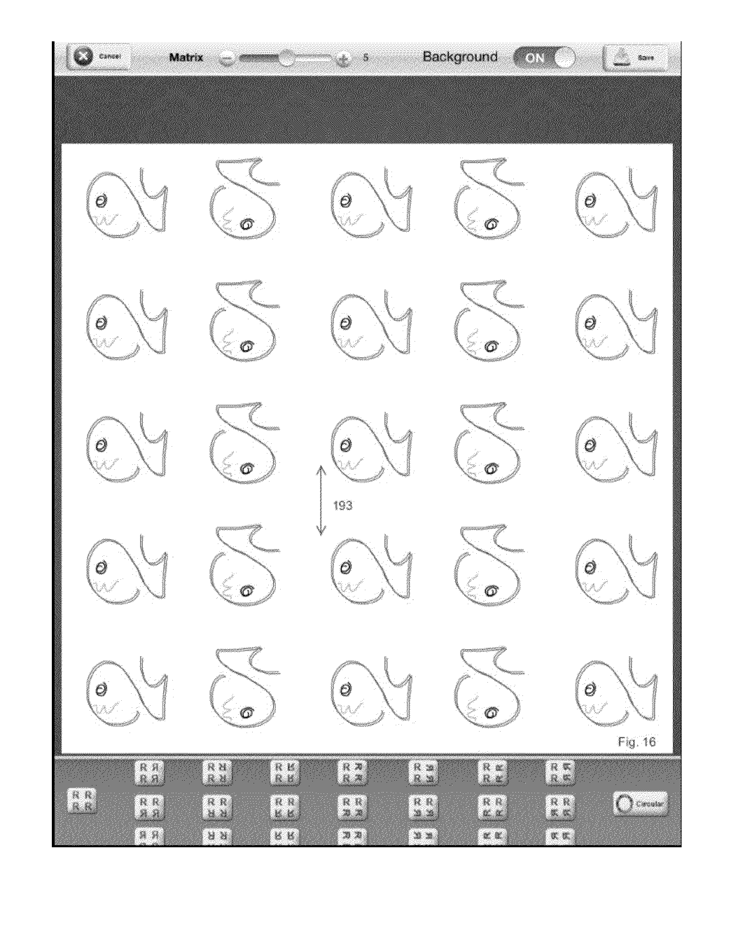

FIG. 13 shows the design of FIG. 9 using a repeating row function. Referring to FIG. 13, each row 192 has a common orientation, shown alternating from 0 degrees to rotated left 90 degrees. FIG. 14 shows the design of FIG. 9 using repeating columns. In FIG. 14, each column 193 shares a common orientation, shown alternating rotation of 180 degrees. FIG. 15 shows the design of FIG. 9 using a matrix function, such that an arbitrary M*N matrix of image 116-2 renderings is performed, shown as an 8*8 matrix alternating by column.193. FIG. 16 shows the design of FIG. 9 using a column 193 rotation function, such that each column 193 is rotated.

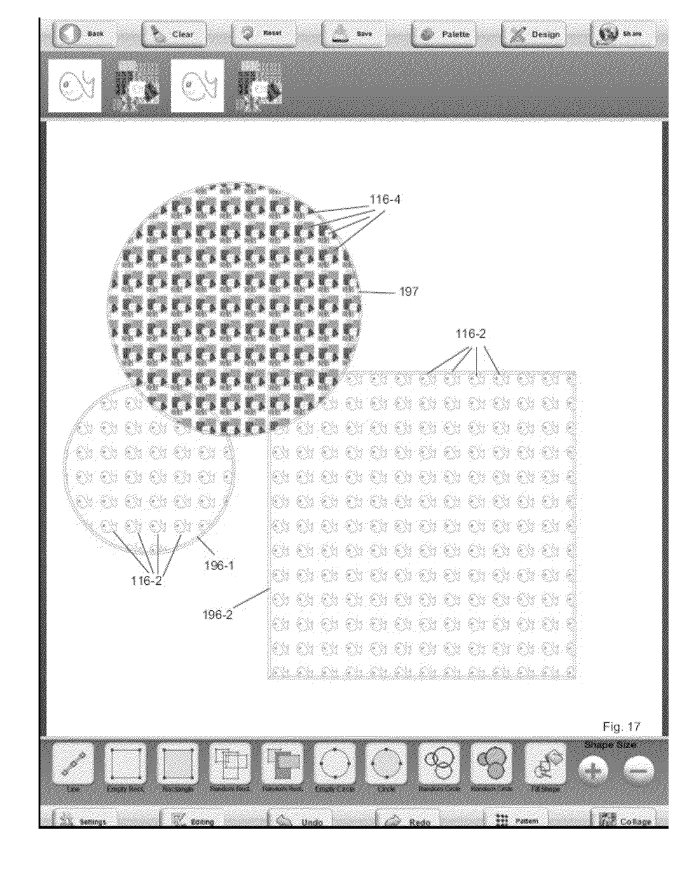

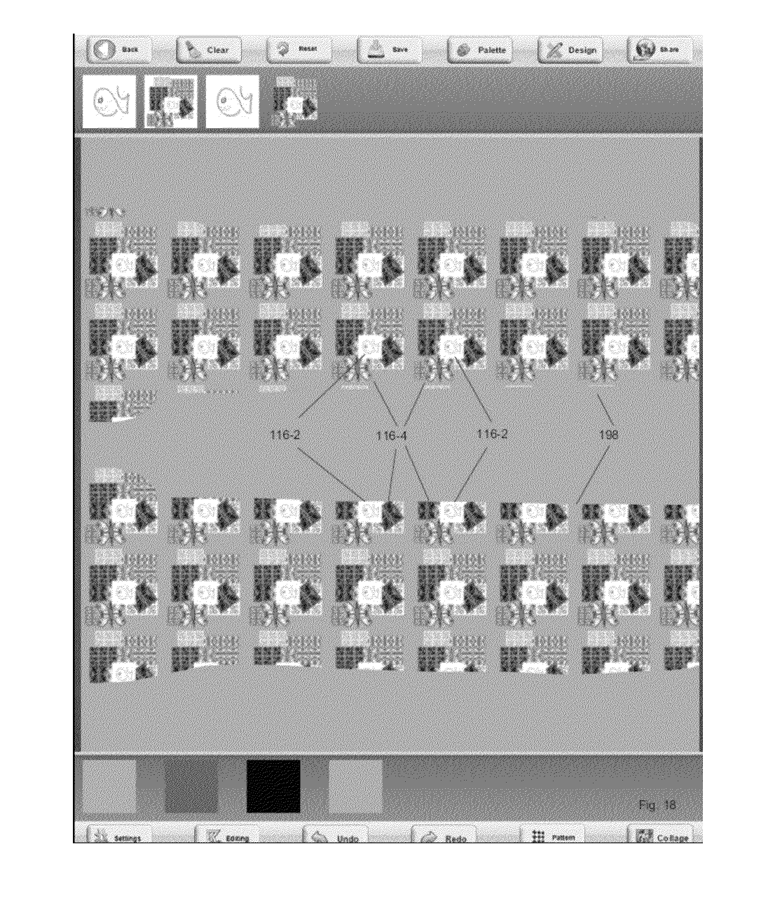

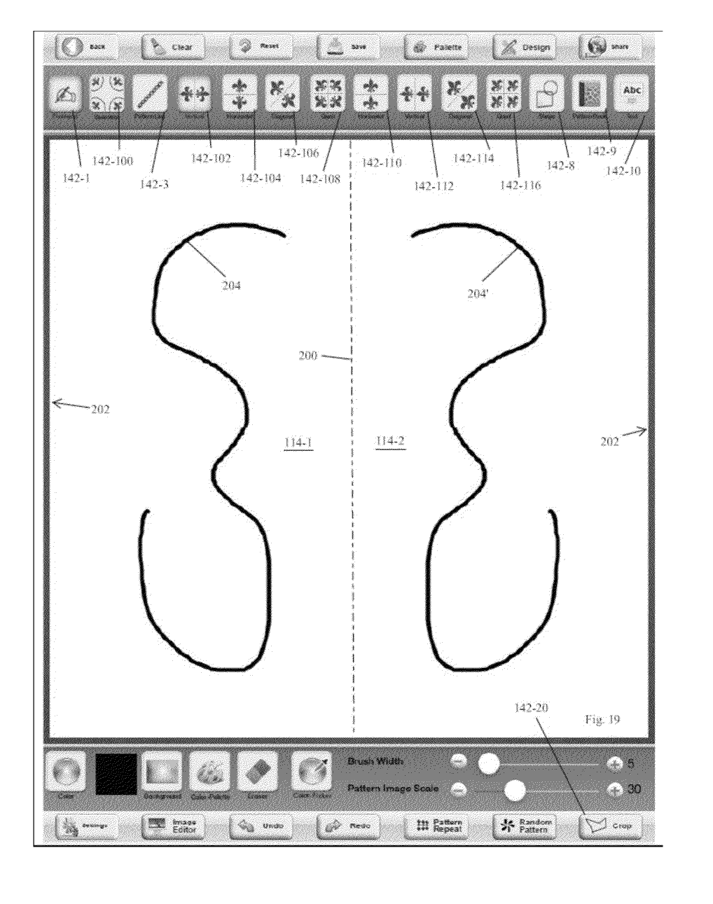

The image manipulation functions may be compounded and aggregated, as disclosed above. FIG. 17 shows a shape function and fill using the designs of FIGS. 9 and 11. Referring to FIGS. 4, 9 and 11, the shapes function 142-8 draws shapes 196-1 and 196-2 using image 116-2 as the fill pattern, and shape 197 using image 116-4 as the fill pattern. Note further that image 116-4 also includes a rendering of image 116-2, showing the nested or hierarchical capability. FIG. 18 shows a pattern line using the design of FIG. 11. In a similar manner, a double pattern line 198 (occupying almost the entire canvas, or rendering area 114) employs image 116-4 as the drawing medium, which incorporates image 116-2.

The physical form of the disclosed approach may take the form of pattern based design tool, operable on a computing device 100, including a plurality of image building functions for generating visual content, the canvas responsive to graphical manipulations for changing the appearance of an image on the canvas, and a plurality of image manipulation functions for modifying the visual content to generate a modified image. A rendering area 114 on the design tool defines a canvas for accumulating visual content configured to depict invocation of the image building functions and the image manipulation functions.

Referring again to FIGS. 1 and 2, the design tool may be implemented by an application (app) 112 operative for launch and execution on the computing device. The app 112 is configured for selecting an image building function for adding visual content on a canvas, in which the canvas is responsive to graphical manipulations for changing the appearance of an image 150 on the canvas. The user 110 selects an image manipulation function for modifying the visual content on the canvas to generate a modified image 150. The app 112 allows repetitive or iterative selection of the image building functions and the image manipulation functions to accumulate an aggregate image based on successive modified images. The image building and manipulation functions allow selection the aggregate image and employing the aggregate image (subimage 150′) as an element of an image building function in a successive image 150. The app 112 performs saving of the aggregate image in a repository 124 of selectable images, and successive recall, such that subsequently invoked building functions add visual graphical material to an image via the canvas. The image manipulation functions may also be invoked, in any suitable order, for modify the rendering in the canvas by reorganizing material already rendered.

The user device as disclosed herein refers to any suitable portable or stationary computing device, such as handheld devices commonly known as smartphones, tablets, notebooks, PDA (Personal Digital Assistant), and laptops, as well as desktop computers, characterized by a user display or visual rendering area, user input facilities such as keypads (often rendered on the display), pointing devices such as a mouse, touchpad, trackball, or pointer, and a memory/processor configuration for launching and executing applications (apps) including instructions for receiving input from the user and rendering results sought by the user. Such various computing facilities suitable for use with configurations herein may be employed for providing the system, methods and apparatus described.

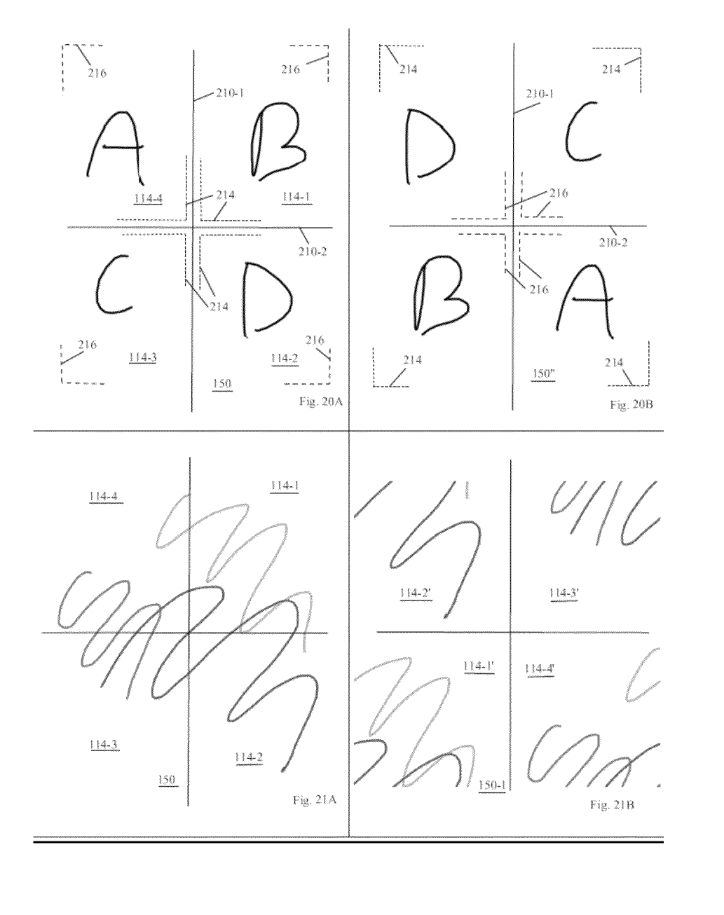

FIG. 19 depicts a graphical user interface having partition based image manipulation and building functions. Referring to FIGS. 1, 4 and 19, in a graphical design environment having a canvas (denoted as rendering area 114 on the device 100) for rendering visual depictions of images generated from image building functions and image manipulation functions, a method for drawing a visually rendered pattern subdivides the rendering area 114 into a plurality of portions 114-1 . . . 114-2, such that each rendering area 114-N renders a line corresponding to the pointer input. Multiple lines are drawn (rendered) in each partitioned area 114-N responsive to user pointer input. A variety of image building functions and image manipulation functions operate on the partitioned image 114-1 . . . 114-N. Further, the partitions may be reassembled to define subimages with different borders that combine with adjacent subimages, as in a pattern line function, to alter the appearance of “hard” or “fixed” boundaries in the resulting pattern and provide a seamless appearance.

A vertical partition tool 142-102 superimposes a partition line 200 vertically through the rendering area 114 to denote partitions 114-1 and 114-2. A drawing operation, such as line 204, occurring in either of the partitions 114-N results in a corresponding rendering simultaneously in the opposed partition 114-N. The corresponding feature, such as line 204′, occurs reversed, as a minor image, as shown by the opposed tridents in the icon button for the vertical partition tool 142-102. A duplicated line having the same, rather than an inverse, orientation is provided by tool 142-112, denoted by similarly oriented tridents.

With employed with the pattern line tool 142-3, rather than the freehand tool 142-2 as in FIG. 19 as shown, the application 112 receives a selection of a first image 150 and an image building function, and renders, based on the received selection, a second image based on iterative duplication of the first image according to the image building function, thus employing the first image as a subimage 150′ in the line or other image 150 generated by the image building function. The partition tools thus perform rendering a plurality of lines simultaneously based on a common pointer input, drawing the corresponding line 204′ or pattern line simultaneously.

The partition based tools generally operate by defining a plurality of portions 114-N from subdividing the rendering area 114, and determine an association between the partitions 114-N indicative of corresponding points. The rendering area 114, in the examples that follow, is either bifurcated horizontally or vertically through the middle, or quartered into equal quadrants. Other partitions could be performed, such as unequal splits (25%/75%) or employing other polygonal shapes, discussed below. Once partitioned, image building functions (drawing functions) 142 simultaneously render an image based on pointer input in each of the partitions 114-N based on the corresponding points defined by the association, thus drawing 2 or 4 lines simultaneously.

The partitioning therefore defines an association between the corresponding partitions 114-N. Typically this is typically a regular or inverse orientation, meaning that the image in the corresponding partition (line or other foreground feature) follows the same drawing direction or a mirror image direction, thus the association may define a reverse image association between the partitions. In the case of a quadrant arrangement, the association may defines an alternating positive and reverse image between each of quadratically partitioned portions 114-N.

Since the pattern line tool 142-3 employs the first image as a subimage 150′ within a second image 150, the rendering of the second image includes adjacent, resized renderings of the first image for defining a subimage in the second image. The result is that each of the first and second images result from drawing, based on a received drawing command, a visual rendering of an image on the canvas, the canvas defined on a device 100 for displaying the visual rendering (i.e. canvas is displayed in rendering area 114). In other words, images 150, 150′ may define a nesting or hierarchy of images rendered within each other, discussed further below.

The partitioning may also be employed for subdividing and recombining the images prior to incorporation in a pattern line or other subimage 150.′ This includes defining an image 150 as a pixelated rendering on the graphical device 100, and partitioning and recombining the image to generate a continuous image forming continuous foreground features with an adjacent, reproduction of the defined image. Partitioning may rearrange the image such that interior lines defined by the partition line 200 become exterior lines 202, which meet at the exterior line 202 of an adjacent subimage 150′ when rendered in a pattern line. The application 112 designates the defined continuous image 150 as a sub-image 150′ available for visual rendering via a drawing operation, and rendering the sub-image 150′ as a repeated element in a current image rendered on the graphical device. Thus, the partitioning may lead to recombining by moving and/or exchanging partitions to define a new image, which then evolves to a subimage when saved and invoked from the library of patterns.

An image 150 saved in the library or palette is utilized as a subimage 150′ by selecting a drawing operation, and incorporated, via the selected drawing operation, the subimage 150′ as a repeated element in a current image rendered on the rendering area 114 on the graphical device 100, in which the current image 150 includes repeated renderings of the subimage 150′ based on the drawing operation (such as a pattern line). In the example of FIG. 19, the drawing operation may include rendering a first line or pattern line 142-3 based on pointer input, and rendering a second line in a corresponding portion of a split rendering area, in which the rendering area is defined by a vertical subdivision of the available on-screen area of the rendering device. Other partitioning and associations are available. Discussed below are partitioning operations and transformations that subdivide the canvas according to one or more partitions and reflect features across the partition lines. The examples focus on bisected and quadrant partitions defined by 180 degree and 90 degree relations, respectively, but any suitable angular relation may be employed. In general, the depicted functions operate to:
Split the image vertical into 2 halves
Swap the 2 halves vertically
Split the result image horizontally into 2 halves
Swap the 2 halves horizontally
Get the four quadrants of the result image and use for further usage of the tiles.
nested iterations to recursively define a hierarchy of partitions.

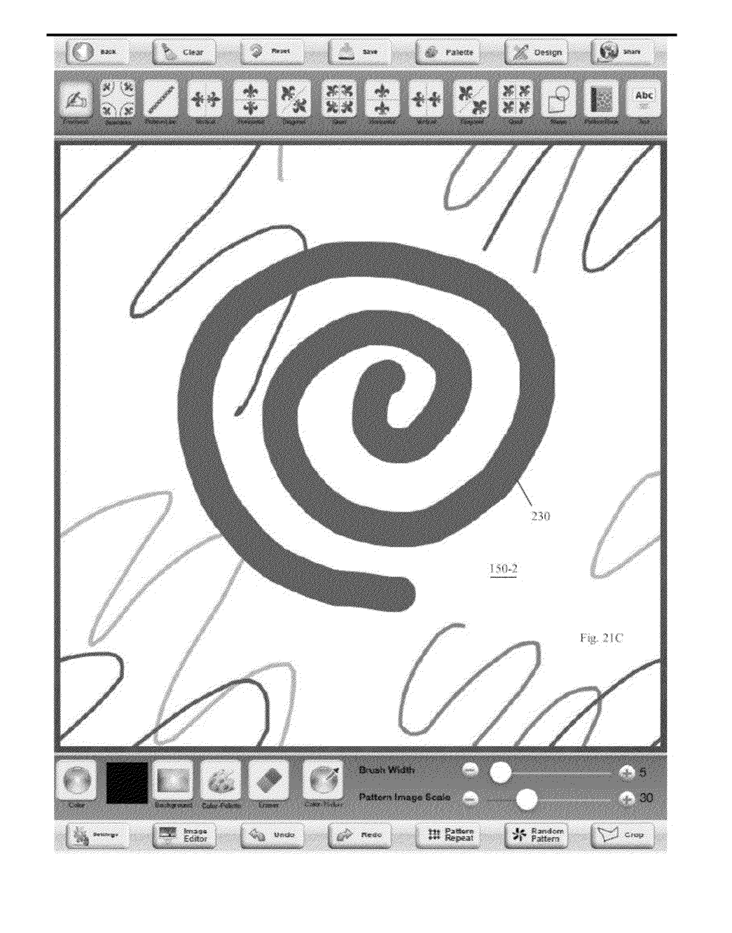

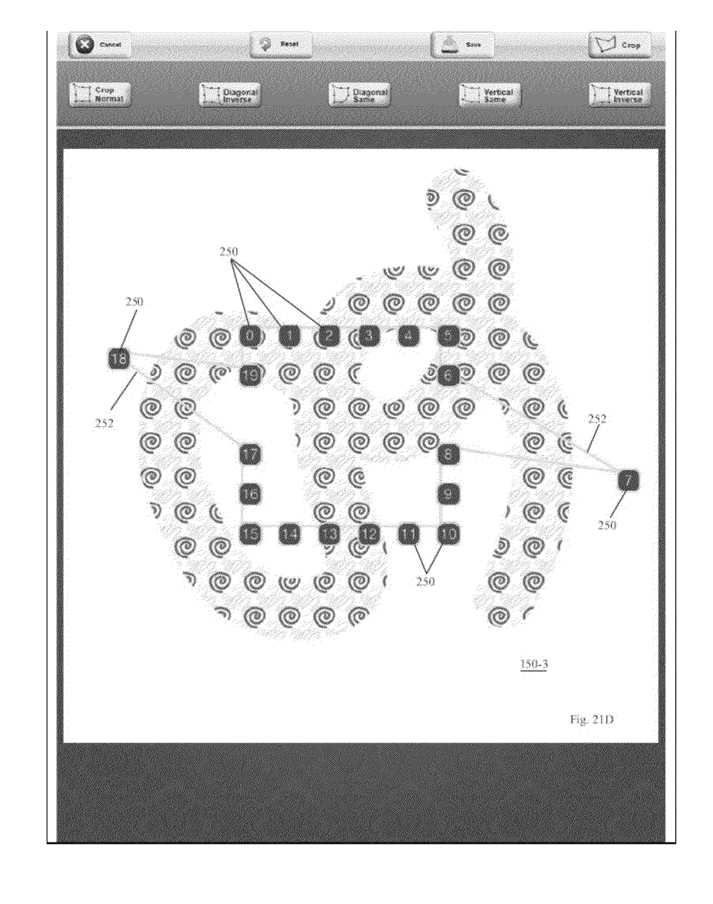

FIGS. 20A-21D show a quadrant based image manipulation function for generating seamless edges between adjacent subimages 150′. Referring to FIGS. 19, 20A and 20B, a quadrant partitioning is shown. In FIG. 20A, quadrant partition lines 210-1 and 210-2 (vertical and horizontal) partition the rendering area into quadrants 114-1 . . . 114-4. An image manipulation function 142-100 recombines the partitions 114-1 . . . 114-4 in opposed quadrants such that interior edges, shown by tight dotted lines 214 and exterior edges, shown by longer dashed lines 216, are inverted, as shown in FIG. 20B. This allows a pattern line 142-3 of successive subimages 150′ to appear seamless as the subimages 150′ are concatenated. This partitioning and recombination performed by the seamless function 143-100 generates a graphical design by partitioning the pixelated image in the rendering area 114 on the rendering device 100, such that the partitioning defines corresponding edges 200, 210. The application 112 reorients and recombines the partitions into a repeatable, continuous rendering by iteratively duplicating the recombined partitions 114-N to define a recombined image 150″ of FIG. 20B. The recombination depicted in FIG. 20B inverts the interior edges 214 and exterior edges 216 from the initial image 150 (FIG. 20A), however other recombination approaches may be performed. During a pattern line 142-3 function, the recombined image 150″ is duplicated by aligning recombined partitions along the corresponding edges 214 (interior edges inverted to exterior) of the pixelated image 150″ such that the former interior edges meet to appear as a seamless, unbroken image. In other words, as shown in FIGS. 21A and 21B, the quadrants 114-1 . . . 114-4 are reorganized along diagonals, such that 114-1 becomes 114-1′, 114-2 moves to 114-2′, 114-3 moves to 114-3′ and 114-4 moves to 114-4′.

The corresponding edges are based on an interior line (200 or 210) through the pixelated image, such that the recombined partitions 114-N defining the corresponding edges (interior) at an exterior line of the recombined image 150″. Such alignment has the effect of joining foreground features from the pixelated image 150″ for appearing continuous across the corresponding edges in adjacent, duplicated recombined images when redrawn in the pattern line 142-3 manner. Other image building functions may also employ the seamless arrangement, in which the image building function is a drawing operation for adding graphical material by repeated renderings of a resized image, such that the resized image is based on applying an image manipulation function to a previous canvas, or previously generated image now employed as a subimage 150″.

The pattern line drawing function 142-3 renders adjacent subimages along exterior lines. The seamless function 142-100 partitions the image 150 to generate a subimage 150″ with the interior lines removed to the exterior. Interior lines become exterior in the recombined image such that they form a seamless integration with adjacent subimages in a subsequent pattern line 142-3. This evolution is depicted in FIGS. 21A-21D, where an image 150′ (FIG. 21A) undergoes a seamless function 142-100 function to generate the image 150-1 in FIG. 21B. FIG. 21C depicts the image 150-1 in the application 112, and a spiral feature 230 is added to form image 150-2. The seamless function 142-100 has partitioned the pixelated image 150 into a repeatable subimage 150-1 by subdividing the subimage along at least one interior line (horizontal and vertical in FIG. 21B). Following addition of the spiral 230, FIG. 21D shows a pattern line 142-3 rendering from recombining the partitions 114-N into a repeatable, continuous rendering by iteratively duplicating the repeatable subimage 150-2. The resulting repeatable continuous rendering 150-3 has foreground features rendered to appear continuous with corresponding foreground features in an adjacent subimage of recombined partitions 114-N, and renders the recombined subimage 150-2 via the drawing operation (pattern line 142-3) such that the boundaries/edges between adjacent renderings appear continuous and seamless.

FIG. 21D also depicts a crop function rendered as numerical boxes forming a generally square outline. The crop drawing function 142-20 crops the rendered image on the canvas according to a sequence of dots, such that the sequence of dots is ordered and positioned in response to user input. The dots 250, appearing as numbered boxes 1-20, may be drawn to form a shape by a line 252 connecting the dots, and the area outside the reshaped line cropped. Alternatively, the area inside the line 252 may be cropped. Dot 250 selection and movement may be further augmented by corresponding diagonal and inverse relations between the dots, where dots move in conjunction with their counterparts on an opposed side of the square.

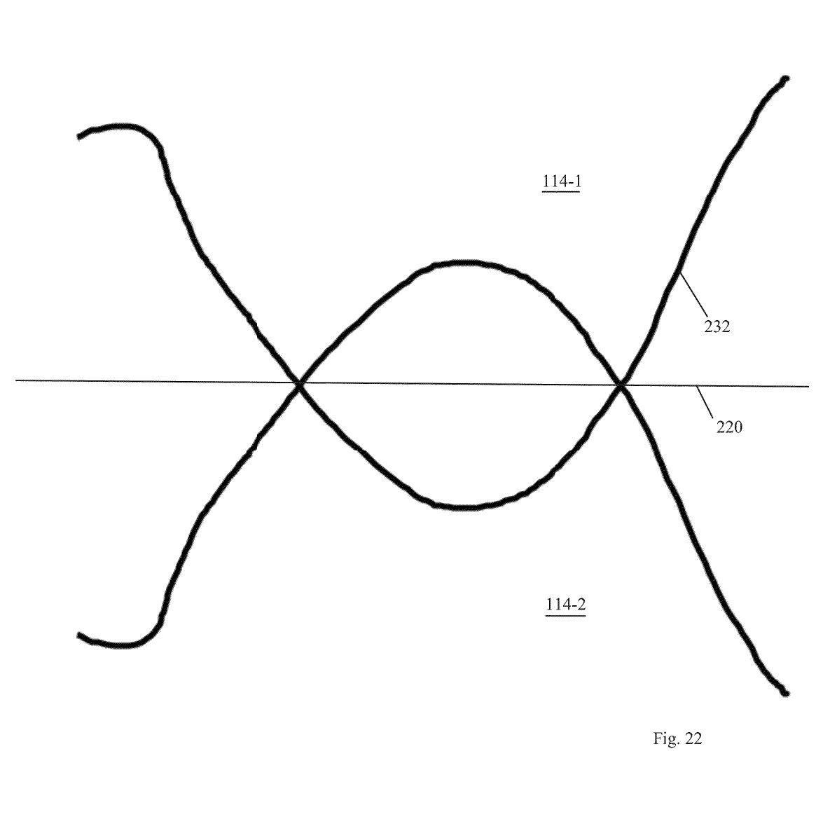

In another variation on partitioning and recombining, FIG. 22 depicts a horizontal bifurcation similar to the vertical bifurcation of FIG. 19. In FIG. 22, a rendered, drawn feature 232 renders a second line in a corresponding portion 114-2 defined by a bifurcation along a horizontal line 220. Various alternatives on partitioning may be performed. While the example depict 2-way bifurcation or quadrant divisions, partitions may be defined along other lines as well. For example, the partitions 114-N may be defined by a polygon for rendering the portions in equal subdivisions around an edge of the defined polygon, such as a hexagon or octagon kaleidoscope form.

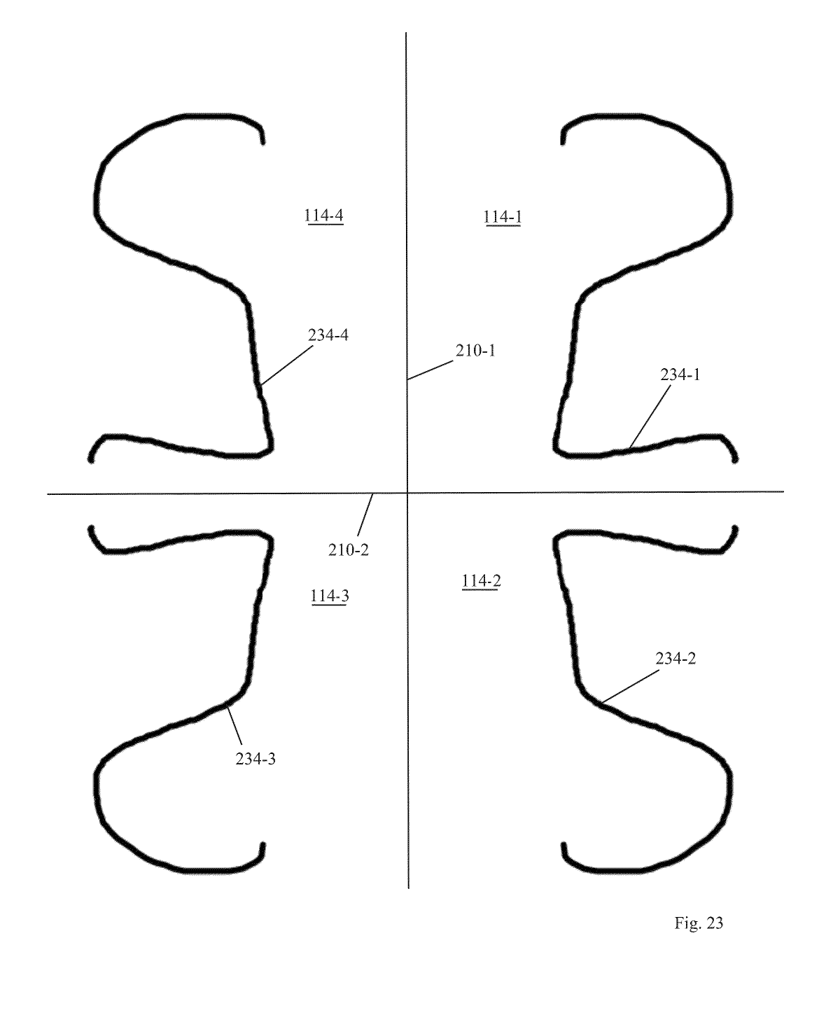

FIG. 23 depicts a quadrant partition with inverse reflection. Referring to FIG. 23, quadrant lines 210-1 and 210-2 partition the rendering area 114 into quadrants 114-1 . . . 114-4. An inverse quad drawing function 142-108 operates such that at least one of the partitions 114-N renders an inverse line, such that the inverse line defined by an inverted image of the first rendered line. In the example shown, upon rendering a line feature 134-1 in partition 114-1, an inverted minor image, as if the image was “folded” across the quadrant lines 210-1 and 210-2, is drawn simultaneously as features 234-2, 234-3 and 234-4, in respective partitions 114-2, 114-3 and 114-4.

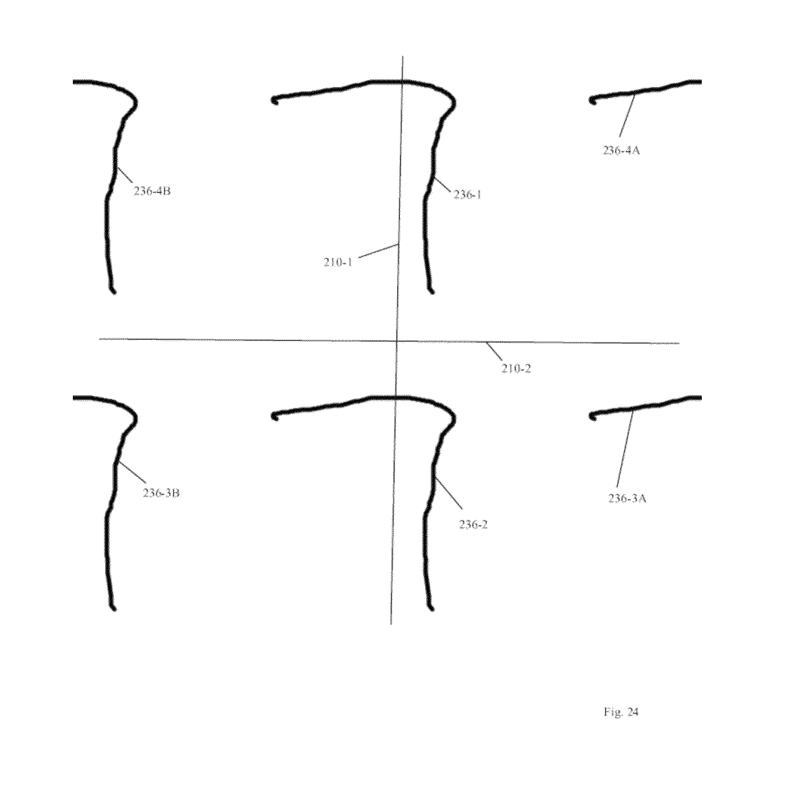

FIG. 24 depicts a quadrant partition with corresponding (same orientation) reflection, resulting from drawing function 142-116. Note that each of the 4 corresponding features 236-1 . . . 136-4 proceeds in the same, not inverse, direction, and wraps to an opposed side of the rendering area 114 upon crossing the partition 210, as shown by subdivided features 236-4A, 236-4B and 236-3A, 236-3B.

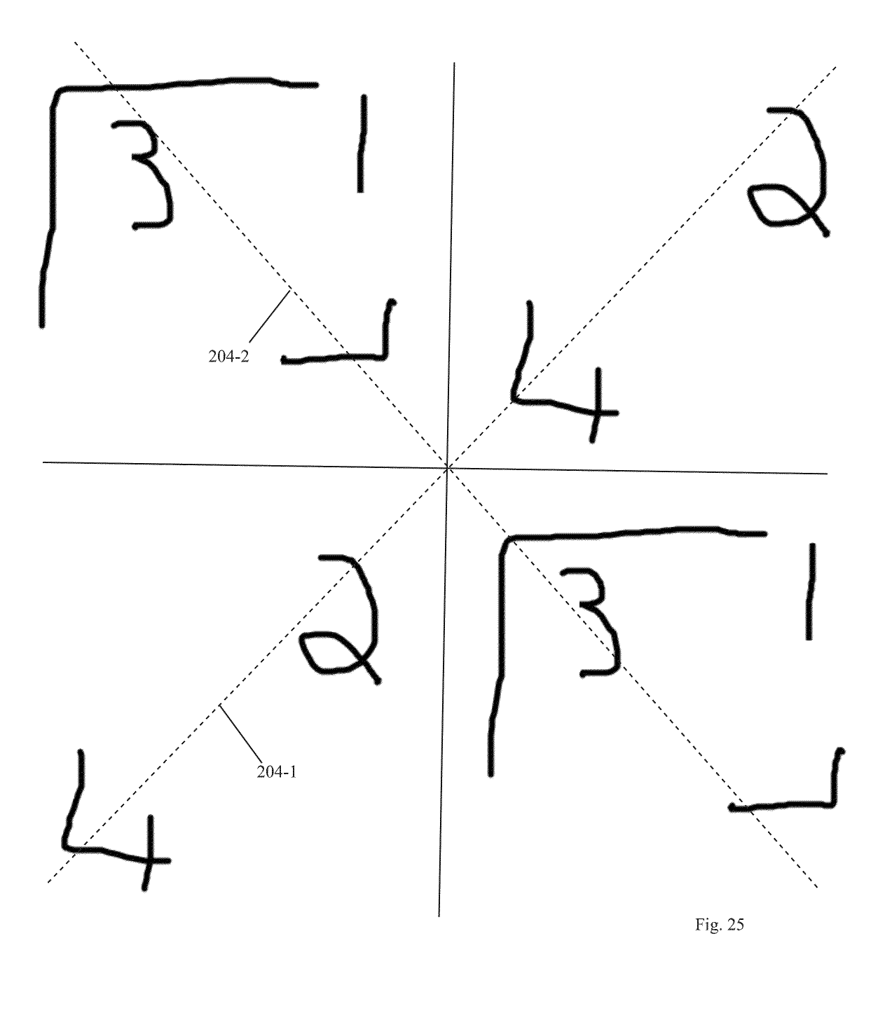

FIG. 25 depicts a quadrant partition with diagonal reflection. The diagonal reflection function 142-114 of FIG. 25 projects a corresponding simultaneous feature across a diagonal partition 204-1, 204-2 such that features are duplicated in the diagonal quadrant.

Application 112 features allow the above described partitioning as follows. When the crop screen is launched, a mode is selectable. The modes define the rendering (display) of complementary points based on the partition, as follows:
Normal Mode—In this mode, the cropping area can be dynamic and random in shape
Vertical Same—In this mode, the cropping area is created by symmetric vertical positioning of points in the same direction across x axis
Vertical Inverse—In this mode, the cropping area is created by symmetric vertical positioning of points in the opposite direction across x axis
Diagonal Same—In this mode, the cropping area is created by symmetric diagonal positioning of points in the same direction across x and y axis
Diagonal Inverse—In this mode, the cropping area is created by symmetric diagonal positioning of points in the opposite direction across x and y axis

FIG. 26A depicts partitioning based on arbitrary angles. In contrast to the 90 degree quadrant partitioning shown above, partitioning may also be applied at an arbitrary angle by transforming points according to the desired angle. In FIG. 26A, partition lines 230-1 . . . 230-3 define 60 degree relations, to subdivide into 6 partitions A-E. Other orientations, such as octagonal (45 degree) partitions or any arbitrary subdivision may be employed.

FIG. 26B shows interconnected partitions defined at a 60 degree angle. Partitions performed at particular angles, such as quadrant and hexagonal, allow the partitions to tile together to form a larger image, since the defined boundaries align for interconnection with adjacent, similarly shaped partitions, thus providing coverage with no overlaps or gaps. Each partition line 230 may be part of a larger tiling defined by other partition lines 230′.

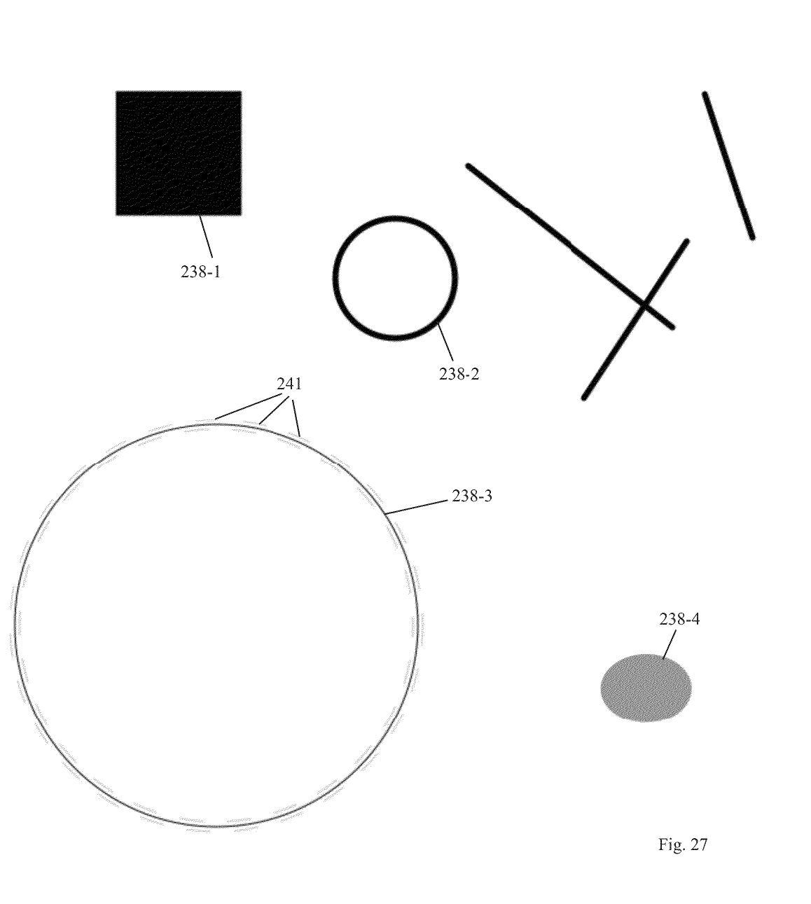

FIG. 27 depicts shape and enhancement drawing operations. Particular functions operate to render geometric shapes of filled and outline formats. The rendered shapes are modifiable with respect to dimension and fill color for providing additional features. Thus, the drawing function 142-8 receives a selection of a two dimensional shape 238-1 . . . 238-4, and renders the selected shape in the rendering area 114. 24. Further, an animated enhancement function provides an animated appearance, such that the animated appearance is achieved by rendering hash markings 241 around foreground features 238.

Other features include a hierarchy of images, which broaden into a series of revisions reflecting a hierarchy, as in a base image modified 3 ways and saved as three different images all sharing the same base image. The hierarchy may define a plurality of layers, such that each subimage in the hierarchy defining a layer, and further allowing selectively rendering of layers on the canvas (rendering area 114) in response to received commands.

Drawing operations also include a hue inversion, which modifying a rendered color based on an opposed location on a color wheel as shown in FIG. 6. For example, an inverse color may be defined as 180 degrees opposed on the color wheel 170.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for generating a graphical design, comprising:
partitioning the pixelated image on a rendering device, the partitioning defining corresponding edges;
recombining the partitions into a repeatable, continuous rendering by iteratively duplicating the recombined partitions to define a recombined image; and
aligning the duplicated recombined partitions along the corresponding edges of the pixelated image.

2. The method of claim 1 wherein the corresponding edges are based on an interior line through the pixelated image, the recombined partitions defining the corresponding edges at an exterior line of the recombined image.

3. The method of claim 2 wherein the alignment joins foreground features from the pixelated image for appearing continuous across the corresponding edges in adjacent, duplicated recombined images.

4. In a graphical design environment having a canvas for rendering visual depictions of images generated from image building functions and image manipulation functions, a method for drawing a visually rendered pattern, comprising:
receiving a selection of a first image and an image building function; and
rendering, based on the received selection, a second image based on iterative duplication of the first image according to the image building function.

5. The method of claim 4 further comprising rendering a plurality of lines simultaneously based on a common pointer input.

6. The method of claim 4 further comprising:
defining a plurality of portions by subdividing the rendering area;
determining an association between the portions indicative of corresponding points; and
simultaneously rendering an image based on pointer input in each of the portions based on the corresponding points define by the association.

7. The method of claim 6 wherein the association defines a reverse image association between the portions.

8. The method of claim 6 wherein the association defines an alternating positive and reverse image between each of quadratically partitioned portions.

9. The method of claim 4 wherein the rendering of the second image includes adjacent, resized renderings of the first image for defining a subimage in the second image.

10. The method of claim 8 wherein each of the first and second images result from drawing, based on a received drawing command, a visual rendering of an image on the canvas, the canvas defined on a device for displaying the visual rendering.

11. The method of claim 10 wherein the image building function is a drawing operation for adding graphical material by repeated renderings of a resized image, the resized image based on applying an image manipulation function to a previous canvas.

12. The method of claim 8, further comprising:
defining an image as a pixelated rendering on a graphical device;
partitioning and recombining the image to generate a continuous image forming continuous foreground features with an adjacent, reproduction of the defined image;
designating the defined continuous image as a sub-image available for visual rendering via a drawing operation; and
rendering the sub-image as a repeated element in a current image rendered on the graphical device.

13. The method of claim 12 further comprising:
selecting a drawing operation; and
incorporating, via the selected drawing operation, the subimage as a repeated element in a current image rendered on the graphical device, the current image including repeated renderings of the subimage based on the drawing operation.

14. The method of claim 12 wherein the drawing operation further comprises:
rendering a first line based on pointer input; and
rendering a second line in a corresponding portion of a split rendering area, the rendering area defined by a vertical subdivision of the available on-screen area of the rendering device.

15. The method of claim 14 further comprising rendering the second line in the corresponding portion defined by a bifurcation along a horizontal line.

16. The method of claim 15 further comprising subdividing the rendering area into a plurality of portions, each rendering area rendering a line corresponding to the pointer input.

17. The method of claim 15 wherein at least one of the portions renders an inverse line, the inverse line defined by an inverted image of the first rendered line.

18. The method of claim 17 wherein the drawing operation further comprises:
receiving a selection of a two dimensional shape; and
rendering the selected shape in the rendering area.

19. The method of claim 12 further comprising:
partitioning the pixelated image into a repeatable subimage by subdividing the subimage along at least one interior line; and
recombining the partitions into a repeatable, continuous rendering by iteratively duplicating the repeatable subimage.

20. The method of claim 19 wherein the repeatable continuous rendering has foreground features rendered to appear continuous with corresponding foreground features in an adjacent subimage of recombined partitions, further comprising rendering the recombined subimage via the drawing operation such that the boundaries/edges between adjacent renderings appear continuous.

21. The method of claim 12 further comprising receiving a selection indicative of a resolution and aspect ratio, the drawing operation rendering based on the selected resolution and aspect ratio.

22. The method of claim 12 further comprising storing a hierarchical history of subimages, including:
identifying a parent subimage;
invoking a first drawing operation for modifying the parent subimage
storing the modified subimage as a descendent subimage;
invoking a second drawing operation on an unmodified parent subimage; and
storing the subimage modified by the second drawing operation as a second descendent image, the second descendent subimage having common features with the parent subimage and the first descendent subimage, and omitting features resulting from the first drawing operation.

23. The method of claim 22 wherein the hierarchy defines a plurality of layers, each subimage in the hierarchy defining a layer, further comprising selectively rendering layers on the canvas in response to received commands.

24. The method of claim 12 wherein the drawing operation further comprises an animated appearance, the animated appearance achieved by rendering hash markings around foreground features.

25. The method of claim 12 wherein the drawing operation includes a hue inversion, the hue inversion modifying a rendered color based on an opposed location on a color wheel.

26. The method of claim 12 wherein the partitions are defined by a polygon for rendering the portions in equal subdivisions around an edge of the defined polygon.

27. The method of claim 12 wherein the drawing function crops the rendered image on the canvas according to a sequence of dots, the sequence of dots ordered and positioned in response to user input.

28. A computer program product on a non-transitory computer readable storage medium having instructions for performing a method for generating graphical designs, the method comprising:
defining an image as a pixelated rendering on a graphical device;
partitioning and recombining the image to generate a continuous image forming continuous foreground features with an adjacent, reproduction of the defined image;
designating the defined continuous image as a sub-image available for visual rendering via a drawing operation;
rendering the sub-image as a repeated element in a current image rendered on the graphical device; and
rendering a plurality of lines simultaneously based on a common pointer input.
